(19) United States
(12) Patent Application Publication
(10) Pub. No.: US 2025/0126317 A1
(43) Pub. Date: Apr. 17, 2025

(54) Video Processing Method and Related Device

(71) Applicant: Huawei Technologies Co., Ltd., Shenzhen (CN)

(72) Inventor: Shengli Luo, Nanjing (CN)

(21) Appl. No.: 18/999,471

(22) Filed: Dec. 23, 2024

Related U.S. Application Data
(63) Continuation of application No. PCT/CN2023/101124, filed on Jun. 19, 2023.

(30) Foreign Application Priority Data
Jun. 24, 2022 (CN) 202210733723.7

(51) Int. Cl. H04N 21/431; H04N 21/234; H04N 21/472

(52) U.S. Cl. CPC H04N 21/4318; H04N 21/23424; H04N 21/47217

(57) ABSTRACT

A video processing method includes that, in a scenario of an aggregated video, because different service providers (SPs) may insert one or more clips into or crop one or more clips from a basic video, offset information of the one or more clips is calculated during operation of the video; and after detecting a switching operation of a user, an electronic device may calculate a continuous playback location based on parameters such as the offset information of the one or more clips and elapsed play duration of the video during the switching operation of the user.

### CROSS-REFERENCE TO RELATED APPLICATIONS

This is a continuation of International Patent Application No. PCT/CN2023/101124 filed on Jun. 19, 2023, which claims priority to Chinese Patent Application No. 202210733723.7 filed on Jun. 24, 2022. The disclosures of the aforementioned applications are hereby incorporated by reference in their entireties.

### TECHNICAL FIELD

This disclosure relates to the field of terminal technologies, and in particular, to a video processing method and a related device.

### BACKGROUND

With rapid development of terminal technologies and network technologies, online videos gradually become an important way to obtain information in people's life.

A service provider (SP) provides video content during operation of the online videos. The service provider may be a playback source or a playback platform of different video content. Because different service providers may insert some clips into videos/crop some clips from the videos, playback progresses of a same image in a same video may be different in different SP instances. Therefore, in some scenarios (for example, a user switches a clip video to an entire video, or a user switches between different SP instance videos of an aggregated video), a same image may not be accurately located for continuous playback, resulting in poor user experience.

### SUMMARY

Embodiments of this disclosure provide a video processing method and a related device. After detecting a switching operation (for example, an operation of switching a clip video to an entire video, or an operation of switching a source SP instance video to a destination SP instance video) of a user, an electronic device can accurately calculate a continuous playback location, to resolve a problem that video images before and after switching are discontinuous. This improves user experience.

According to a first aspect, an embodiment of this disclosure provides a method, applied to an electronic device. The method includes that the electronic device plays a first video. The electronic device displays a first user interface, where the first user interface includes a first image, and the first image is an image in the first video. The electronic device detects a first operation of a user when the electronic device displays the first user interface. The electronic device plays a second video in response to the first operation. The electronic device displays a second user interface, where the second user interface includes the first image, and the first image is an image in the second video. Both the first video and the second video are generated based on a third video, a playback progress corresponding to the first image in the second video is a first time point, the second video is obtained by inserting one or more first clips into and/or cropping one or more first clips from the third video before the first time point, and the third video does not include the one or more first clips.

According to the method provided in the first aspect, after the electronic device detects an operation of switching the first video to the second video by the user (for example, an operation of switching a clip video to an entire video, or an operation of switching a source SP instance video to a destination SP instance video), even if the second video (for example, an entire video or a destination SP instance video) is obtained by inserting one or more clips and/or cropping one or more clips, the electronic device can still accurately calculate a continuous playback location, to resolve a problem that video images before and after switching are discontinuous. This improves user experience.

In a possible implementation, the first video is a video clip in the second video.

In view of this, when the first video is a clip video, even if the second video (for example, an entire video) is obtained by inserting one or more clips and/or cropping one or more clips, a continuous playback location can still be accurately calculated, to resolve a problem that video images before and after switching are discontinuous. This improves user experience.

In a possible implementation, the first video is a video of a first video source, the second video is a video of a second video source, a playback progress corresponding to the first image in the first video is a second time point, and the second time point is different from the first time point.

In view of this, when the first video is a source SP instance video, even if the second video (for example, a destination SP instance video) is obtained by inserting one or more clips and/or cropping one or more clips, a continuous playback location can still be accurately calculated, to resolve a problem that video images before and after switching are discontinuous. This improves user experience.

In a possible implementation, before the electronic device displays a second user interface, the method further includes that the electronic device sends first user information to a server, where the first user information is used by the server to determine, based on the first user information, whether the user has permission to play the second video, and the electronic device plays the second video when the server determines that the user has permission to play the second video.

In view of this, it may be determined whether the user has permission to play the second video. If the user has permission to play the second video, the server may send a playback address of the second video to the electronic device, so that the electronic device may obtain a video resource of the second video based on the playback address of the second video, to play the second video.

In a possible implementation, the first time point is determined based on the third video, elapsed play duration of the first video, and an offset information list of the second video, the offset information list of the second video includes offset information of the one or more first clips, and the offset information includes a location at which the one or more first clips are inserted into/cropped from the third video and offset duration.

In view of this, when the first video is a clip video, the electronic device/server can determine the first time point based on the third video, the elapsed play duration of the first video, and the offset information list of the second video (that is, determine a continuous playback point of the second video), to ensure that video images before and after switching are continuous.

In a possible implementation, before the electronic device displays a second user interface, the method further includes that the electronic device sends a first message to a server, where the first message includes an identifier of the first video, and the identifier of the first video is used by the server to obtain the offset information list of the second video and information about a segmentation point of the third video associated with the first video. The electronic device receives a second message sent by the server, where the second message includes the information about the segmentation point and the offset information list of the second video. That the first time point is determined based on the third video, elapsed play duration of the first video, and an offset information list of the second video further includes that the first time point is determined by the electronic device based on the information about the segmentation point, the elapsed play duration of the first video, and the offset information list of the second video.

In view of this, when the first video is a clip video, the electronic device can determine the first time point based on the information about the segmentation point, the elapsed play duration of the first video, and the offset information list of the second video, to ensure that video images before and after switching are continuous.

In a possible implementation, before the electronic device displays a second user interface, the method further includes that the electronic device sends a third message to a server, where the third message includes the elapsed play duration of the first video. That the first time point is determined based on the third video, elapsed play duration of the first video, and an offset information list of the second video further includes that the first time point is determined by the server based on information about a segmentation point of the third video, the elapsed play duration of the first video, and the offset information list of the second video. The electronic device receives a fourth message sent by the server, where the fourth message includes the first time point and a playback address of the second video.

In view of this, when the first video is a clip video, the server can determine the first time point based on the information about the segmentation point, the elapsed play duration of the first video, and the offset information list of the second video, to ensure that video images before and after switching are continuous.

In a possible implementation, before the electronic device displays a second user interface, the method further includes that the electronic device sends a fifth message to the server, where the fifth message includes the first time point and the playback address of the second video, and the playback address is obtained from the server, and the electronic device receives video stream data sent by the server, where the video stream data is video stream data of the second video after the first time point.

In view of this, the electronic device can obtain, from the server, the video stream data of the second video after the first time point, so that the second video after the first time point can continue to be played.

In a possible implementation, after the electronic device plays a second video, the method further includes that the electronic device displays a third user interface, where the third user interface includes a second image, a playback progress corresponding to the second image in the second video is a third time point, a time interval between the third time point and the first time point is a first interval, and the second video is obtained by inserting one or more clips into and/or cropping one or more clips from the third video between the third time point and the first time point. A playback progress corresponding to the second image in the third video is a fourth time point, a playback progress corresponding to the first image in the third video is a fifth time point, and a time interval between the fourth time point and the fifth time point is a second interval, and the first interval is different from the second interval.

In a possible implementation, the third video includes the first image, and a playback progress corresponding to the first image in the third video is a fifth time point, the fifth time point is determined based on the second time point and an offset information list of the first video, the offset information list of the first video includes offset information of one or more second clips, and the offset information includes a location at which the one or more second clips are inserted into/cropped from the third video and offset duration, and the first time point is determined based on the fifth time point and an offset information list of the second video, the offset information list of the second video includes offset information of the one or more first clips, and the offset information includes a location at which the one or more first clips are inserted into/cropped from the third video and offset duration.

In view of this, when the first video is a source SP instance video, the electronic device/server can determine the first time point based on the second time point, the offset information list of the first video, and the offset information list of the second video, to ensure that video images before and after switching are continuous.

In a possible implementation, before the electronic device displays a second user interface, the method further includes that the electronic device sends a sixth message to a server, where the sixth message includes identification information of the first video and identification information of the second video, the identification information of the first video is used by the server to obtain the offset information list of the first video, and the identification information of the second video is used by the server to obtain the offset information list of the second video, and the electronic device receives a seventh message sent by the server, where the seventh message includes the offset information list of the first video and the offset information list of the second video. The fifth time point is determined by the electronic device based on the second time point and the offset information list of the first video, and the first time point is determined by the electronic device based on the fifth time point and the offset information list of the second video.

In view of this, when the first video is a source SP instance video, the electronic device can determine the first time point based on the second time point, the offset information list of the first video, and the offset information list of the second video, to ensure that video images before and after switching are continuous.

According to a second aspect, an embodiment of this disclosure provides an electronic device. The electronic device includes one or more processors and one or more memories. The one or more memories are coupled to the one or more processors. The one or more memories are configured to store computer program code. The computer program code includes computer instructions. When the one or more processors execute the computer instructions, the electronic device is enabled to perform the method according to any possible implementation of the first aspect.

According to a third aspect, an embodiment of this disclosure provides a computer storage medium. The computer storage medium stores a computer program. The computer program includes program instructions. When the program instructions are run on an electronic device, the electronic device is enabled to perform the method according to any possible implementation of the first aspect.

According to a fourth aspect, an embodiment of this disclosure provides a computer program product. When the computer program product runs on a computer, the computer is enabled to perform the method according to any possible implementation of the first aspect.

### BRIEF DESCRIPTION OF DRAWINGS

FIG. 1 is a diagram of a communication system according to an embodiment of this disclosure;

FIG. 2A, FIG. 2B, FIG. 2C, and FIG. 2D are a schematic flowchart of a video processing method in a scenario of “switching a clip video to an entire video” according to an embodiment of this disclosure;

FIG. 3A, FIG. 3B, FIG. 3C, FIG. 3D, and FIG. 3E are diagrams of a group of user interfaces about triggering “switching a clip video to an entire video” by a user according to an embodiment of this disclosure;

FIG. 4 is a principle diagram of performing continuous playback calculation in a scenario of “switching a clip video to an entire video” according to an embodiment of this disclosure;

FIG. 5A, FIG. 5B, FIG. 5C, FIG. 5D, and FIG. 5E are diagrams of a group of user interfaces of continuous playback performed after a user triggers “switching a clip video to an entire video” according to an embodiment of this disclosure;

FIG. 6A, FIG. 6B, FIG. 6C, and FIG. 6D are a schematic flowchart of another video processing method in a scenario of “switching a clip video to an entire video” according to an embodiment of this disclosure;

FIG. 7A, FIG. 7B, FIG. 7C, and FIG. 7D are a schematic flowchart of a video processing method in a scenario of “switching an SP instance video (a source SP instance video) to another SP instance video (a destination SP instance video) in an aggregated video” according to an embodiment of this disclosure;

FIG. 8A and FIG. 8B are diagrams of user interfaces about triggering “switching an SP instance video (a source SP instance video) to another SP instance video (a destination SP instance video) in an aggregated video” by a user according to an embodiment of this disclosure;

FIG. 9 is a principle diagram of performing continuous playback calculation in a scenario of “switching an SP instance video (a source SP instance video) to another SP instance video (a destination SP instance video) in an aggregated video” according to an embodiment of this disclosure;

FIG. 10A, FIG. 10B, FIG. 10C, and FIG. 10D are diagrams of a group of user interfaces of continuous playback performed after a user triggers “switching an SP instance video (a source SP instance video) to another SP instance video (a destination SP instance video) in an aggregated video” according to an embodiment of this disclosure;

FIG. 11A, FIG. 11B, FIG. 11C, and FIG. 11D are a schematic flowchart of another video processing method in a scenario of “switching an SP instance video (a source SP instance video) to another SP instance video (a destination SP instance video) in an aggregated video” according to an embodiment of this disclosure;

FIG. 12 is a diagram of an internal module of an electronic device, an internal module of a server, and a possible manner of collaboration between internal modules that are included in a process of performing a video processing method according to an embodiment of this disclosure;

FIG. 13 is a diagram of an internal module of an electronic device, an internal module of a server, and a possible manner of collaboration between internal modules that are included in a process of performing another video processing method according to an embodiment of this disclosure;

FIG. 14 is a diagram of a structure of an electronic device according to an embodiment of this disclosure; and

FIG. 15 is a diagram of a structure of a server according to an embodiment of this disclosure.

### DESCRIPTION OF EMBODIMENTS

The following clearly describes the technical solutions in embodiments of this disclosure with reference to the accompanying drawings in embodiments of this disclosure. In descriptions of embodiments of this disclosure, unless otherwise stated, “/” represents “or”. For example, A/B may represent A or B. In this specification, “and/or” merely describes an association relationship between associated objects and represents that three relationships may exist. For example, A and/or B may represent the following three cases: only A exists, both A and B exist, and only B exists. In addition, in descriptions of embodiments of this disclosure, “a plurality of” means two or more than two.

It should be understood that the terms “first”, “second”, and the like in the specification, claims, and accompanying drawings of this disclosure are intended to distinguish between different objects but do not describe a particular order. In addition, the terms “including” and “having” and any other variants thereof are intended to cover a non-exclusive inclusion. For example, a process, a method, a system, a product, or a device that includes a series of steps or units is not limited to the enumerated steps or units, but optionally further includes an unenumerated step or unit, or optionally further includes another inherent step or unit of the process, the method, the product, or the device.

“Embodiment” mentioned in this disclosure indicates that a particular feature, structure, or characteristic described with reference to embodiments may be included in at least one embodiment of this disclosure. The phrase shown in various locations in the specification may not necessarily be a same embodiment, and is not an independent or optional embodiment exclusive from another embodiment. It is explicitly and implicitly understood by a person skilled in the art that embodiments described in this disclosure may be combined with another embodiment.

A term “user interface (UI)” in the following embodiments of this disclosure is a medium interface for interaction and information exchange between an application or an operating system and a user, and implements conversion between an internal form of information and a form acceptable to the user. The user interface is source code written in a specific computer language like JAVA or an Extensible Markup Language (XML). Interface source code is parsed and rendered on an electronic device, and is finally presented as content that can be identified by the user. The user interface is usually represented in a form of a graphical user interface (GUI), and is a user interface that is related to a computer operation and that is displayed in a graphic manner. The user interface may be a visual interface element like a text, an icon, a button, a menu, a tab, a text box, a dialog box, a status bar, a navigation bar, or a Widget that is displayed on a display of the electronic device.

With rapid development of terminal technologies and network technologies, online videos gradually become an important way to obtain information in people's life.

Scenario 1: switching a clip video to an entire video:

During operation of the entire video, a short video clip (or a clip video/video clip) is usually extracted from highlights of the entire video, to improve an exposure rate and a membership conversion rate of the video. The clip video may be independently presented to a user for playback. Further, the clip video may be pushed to the user, so that the user may view the clip video free of charge in pockets of time. In this way, the user is attracted to view the entire video that requires payment.

In order to improve conversion experience for the user who views the clip video and then views the entire video, an association relationship between the clip video and the entire video is usually established on a server (for example, a video management server), when the user plays the clip video, an electronic device obtains a related parameter (for example, a playback address) of a playback page of the entire video based on the established association relationship, and an option of switching to the entire video is set on an interface for viewing the clip video by the user, and after the user taps the option, the electronic device may jump to the corresponding playback page of the entire video.

Further, when the user switches to the entire video during viewing of the clip video, to display, on the playback page of the entire video, an image (or footage) of the clip video played by the user when the user performs a switching operation, and continue to play subsequent images of the video from the image, a common practice is as follows: A timeline location, relative to the entire video, of a playback start location (a playback start time point, or a playback start point) of the clip video is add when the association relationship between the clip video and the entire video is established, then, elapsed play duration of the clip video that has been played by the user is obtained when the user performs the switching operation, and further, a playback start location (or a playback start location, a continuous playback location, a playback start time point, or a continuous playback time point) of the entire video is calculated based on the timeline location, relative to the entire video, of the playback start location of the clip video and the elapsed play duration of the clip video that has been played, so as to complete continuous playback of images.

Scenario 2: switching an SP instance video (a source SP instance video) to another SP instance video (a destination SP instance video) in an aggregated video:

During operation of the aggregated video (an entire video including a plurality of SP playback sources), in order to provide better experience for a user, a function of switching between different SP instance videos may be provided on a playback interface of the aggregated video, so that the user can actively switch to another SP instance video in a possible scenario of differentiated playback quality between different SPs (for example, in a scenario of frame freezing), to ensure that a video playback process can proceed continuously.

To ensure user experience of switching between different SP instance videos, a common practice is as follows: When the user switches a source SP instance video to a destination SP instance video, an electronic device uses, as a playback start location (or a playback start location, a continuous playback location, a playback start time point, or a continuous playback time point) of the destination SP instance video, a playback location of the source SP instance video corresponding to a case in which the user performs a switching operation, to perform continuous playback in the destination SP instance video. In this way, during switching for the user, the electronic device can locate a same image in two different SP instance videos, and perform continuous playback, so as to ensure continuity of video viewing for the user.

However, during actual operation, different SPs may insert some clips into a basic video/crop some clips from the basic video to obtain instance videos corresponding to the different SPs. As a result, playback progresses of a same image in a same video may be different in different SP instance videos. In this case, if calculation methods in the scenario 1 and scenario 2 are still used to determine a continuous playback location, an image played when the user performs the switching operation may not be accurately located in an entire video or a destination SP instance video associated with a clip video, and further a playback location of the image cannot be used as a playback start location of the entire video or the destination SP instance video to perform continuous playback. Therefore, the video before and after switching may not be continuously played, resulting in poor user experience.

In conclusion, it can be learned that, in the scenario 1 (switching the clip video to the entire video) and the scenario 2 (switching the SP instance video to the other SP instance video in the aggregated video), the following three problems need to be resolved.

Problem 1 (a problem caused by switching a clip video to an entire video):

During playback of the clip video, it is assumed that the entire video is an aggregated video. In a case in which the user switches the clip video to the entire video for continuous playback, if different SPs insert different clips into a basic video/crop different clips from the basic video to obtain entire instance videos corresponding to the different SPs, the electronic device cannot perform continuous playback by accurately locating, in the entire instance videos of the different SPs through a same clip video, an image played when the user performs a switching operation (that is, cannot accurately locate continuous playback locations of the entire instance videos of the different SPs through the same clip video). This results in poor user experience.

Further, in an operation scenario of the aggregated video, because the aggregated video comes from a plurality of SPs, in order to improve user experience, same videos from the plurality of SPs need to be integrated into a video-oriented video object. When the user plays the aggregated video, the electronic device may provide a specific video file that can be played by the user for the user based on information such as a user subscription membership. However, during actual operation, because different SPs may insert some clips (such as release information and opening information) into a basic video (an original entire video that does not include clips subsequently inserted/cropped by different SPs) or may crop some clips due to a compliance reason, playback progresses of a same image in a same video may be different in different SP instance videos. Consequently, the electronic device cannot perform continuous playback by accurately locating, in entire instance videos of the different SPs through a same clip video, an image played when the user performs a switching operation.

For example, it is assumed that an aggregated video includes two SP playback sources: an SP-A playback source and an SP-B playback source. Duration of a basic video (an original entire video) is 40 minutes, and a clip video is edited at 00:20:00 and lasts for 3 minutes. It is assumed that in an entire video in the SP-B playback source, a 10-second advertisement clip is inserted into the basic video at 00:20:10, and in an entire video in the SP-A playback source, no advertisement clip is inserted into the basic video. The user performs a switching operation (an operation of jumping to the entire video) when the clip video is played for one minute. If the entire video obtained through switching from the clip video is the SP-A playback source, a playback start location of the entire video is 00:21:00 in normal cases, however, if the entire video obtained through switching from the clip video is the SP-B playback source, and a playback start location of the entire video is calculated according to the current calculation method, the playback start location of the entire video is still 00:21:00. In this case, it can be learned that, when the entire video of SP-B is played, the user needs to view additional images of 10 seconds (images between 00:20:50 and 00:21:00 in the SP-A playback source) that have been viewed in the clip video. In view of this, the playback start location of the entire video of SP-B should be 00:21:10 to ensure continuity of video playback before and after the switching, so as to accurately perform continuous playback.

Problem 2 (a problem caused by switching a clip video to an entire video):

During playback of the clip video, when the user switches the clip video to the entire video for continuous playback, if an SP inserts some clips into a basic video/crops some clips from the basic video to obtain an adjusted entire video, the clip video needs to be adjusted again to ensure that an image played when the user performs a switching operation (a continuous playback location of the adjusted entire video) is accurately located for continuous playback.

Further, during operation of the entire video (including an aggregated video/a non-aggregated video), the SP may insert an advertisement clip into the basic video or suddenly crop some clips due to a regulatory compliance requirement to obtain an adjusted entire video. As a result, a playback progress of the adjusted entire video changes compared with that of the basic video. In this case, a timeline of a clip video obtained by editing the basic video cannot be aligned with that of the adjusted entire video, and a clip video needs to be re-edited and released, resulting in high operation costs.

For example, it is assumed that duration of a basic video (an original entire video) is 40 minutes, and a clip video is edited at 00:20:00 and lasts for 3 minutes. The user performs a switching operation (an operation of jumping to the entire video) when the clip video is played for one minute. In normal cases (that is, no clips are inserted into/cropped from the basic video), continuous playback of the entire video starts from 00:21:00. However, if it is found through subsequent compliance supervision that a 3-second non-compliant image is displayed at 00:20:10 in the basic video, the 3-second image needs to be cropped from the basic video, to obtain an adjusted entire video. Then duration of the adjusted entire video changes to 39 minutes and 57 seconds. In this case, if the user still performs a switching operation (an operation of jumping to the entire video) when the clip video is played for one minute, and a playback start location of the entire video is also calculated according to the current calculation method, without considering time offset information, the playback start location of the entire video is still 00:21:00. However, an image corresponding to the playback start location is changed to an image displayed at 00:21:03 in the unadjusted entire video, and in this case, images of 3 seconds cannot be viewed by the user. In view of this, an accurate playback start location of the adjusted entire video should be 00:20:57 to ensure continuity of video playback before and after switching, so as to accurately perform continuous playback.

Problem 3 (a problem caused by switching one SP instance video to another SP instance video in the aggregated video):

During playback of the aggregated video, when the user switches the SP instance video (a source SP instance video) to the other SP instance video (a destination SP instance video), if different SPs insert some clips into a basic video/crops some clips from a basic video to obtain instance videos corresponding to the different SPs, the electronic device cannot accurately calculate a playback start location of the destination SP instance video (that is, cannot accurately locate a same image in two different SP instance videos). Consequently, continuity of video playback before and after switching cannot be ensured, and continuous playback cannot be accurately performed.

To resolve the foregoing problem, an embodiment of this disclosure provides a video processing method. In a scenario of an aggregated video, because different SPs may insert one or more clips into or crop one or more clips from a basic video, offset information of the one or more clips (for example, location information and duration information of insertion/cropping) is calculated during operation of the video, and after detecting a switching operation of a user (for example, an operation of switching a clip video to an entire video, or an operation of switching a source SP instance video to a destination SP instance video), an electronic device may calculate a continuous playback location based on parameters such as the offset information of the one or more clips and elapsed play duration of the video during the switching operation of the user, so as to resolve a problem that video images before and after switching are discontinuous because the continuous playback location cannot be accurately calculated. This improves user experience.

It is easy to understand that the video processing method may also be applied to a scenario of a non-aggregated video. For example, after an entire video is launched and operated, if some clips are inserted into/cropped from the entire video, or some clips that have been inserted/cropped are adjusted in the entire video, a continuous playback location of the entire video can be accurately calculated without a need to edit and release a clip video associated with the entire video again. This resolves a problem that after the entire video is modified, the clip video needs to be synchronously checked and modified to ensure continuity of video playback before and after switching, so as to accurately perform continuous playback, and therefore reduces operation costs.

The following first describes a communication system provided in an embodiment of this disclosure.

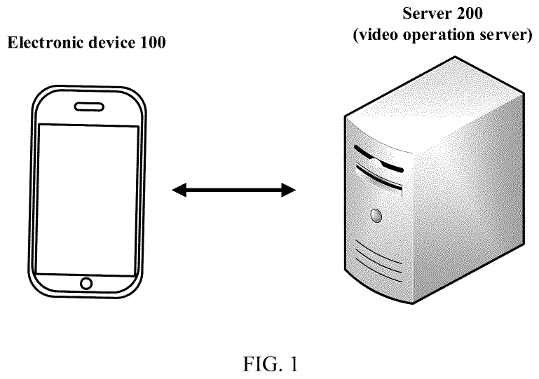

FIG. 1 shows an example of a communication system according to an embodiment of this disclosure.

As shown in FIG. 1, the communication system may include an electronic device 100 and a server 200.

The electronic device 100 may be an intelligent terminal device with a video playback capability. The electronic device 100 may be configured to play a clip video/an entire video, respond to a switching operation of a user (for example, an operation of switching a clip video to an entire video, or an operation of switching a source SP instance video to a destination SP instance video), exchange data with the server 200, and so on.

The electronic device 100 may be of various types. A specific type of the electronic device 100 is not limited in embodiments of this disclosure. For example, the electronic device 100 may be a mobile phone, a tablet computer, a desktop computer, a laptop computer, a handheld computer, a notebook computer, a smart screen, or the like.

The server 200 may be a video operation server. The server 200 may be configured to maintain data during operation of a video (for example, maintain offset information of one or more clips inserted into/cropped from a basic video by different SPs, an association relationship between a clip video and an entire video, and the like), exchange data with the electronic device 100, and so on.

The server 200 may be a cloud server or another server. This is not limited in embodiments of this disclosure.

Specific functions of the electronic device 100 and the server 200 are described in detail in subsequent embodiments, and are not described herein.

It should be understood that FIG. 1 is merely a diagram of an architecture of the communication system, and should not constitute a limitation on this disclosure. A quantity of electronic devices and a quantity of servers included in the communication system are not limited in embodiments of this disclosure.

Scenario 1: switching a clip video to an entire video:

The following describes a specific execution process of a video processing method provided in an embodiment of this disclosure in a scenario of switching a clip video to an entire video.

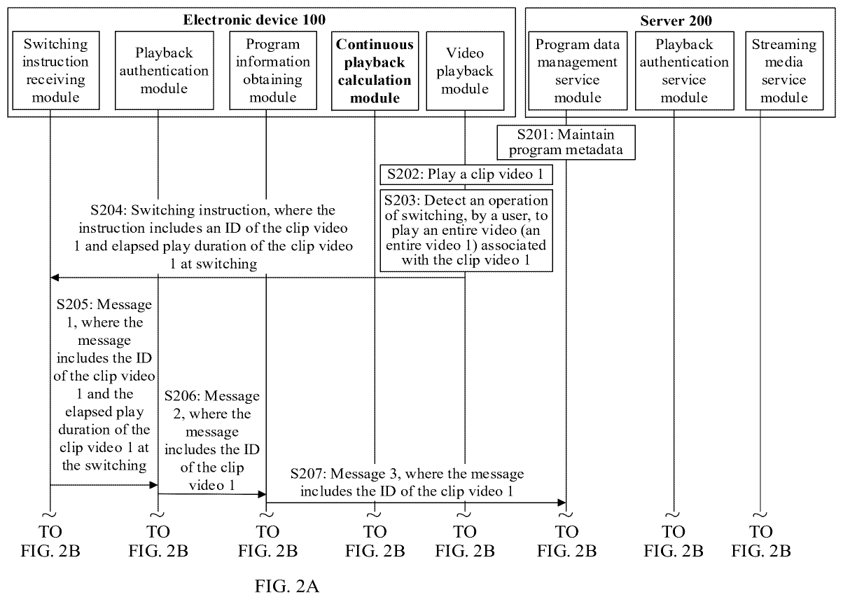

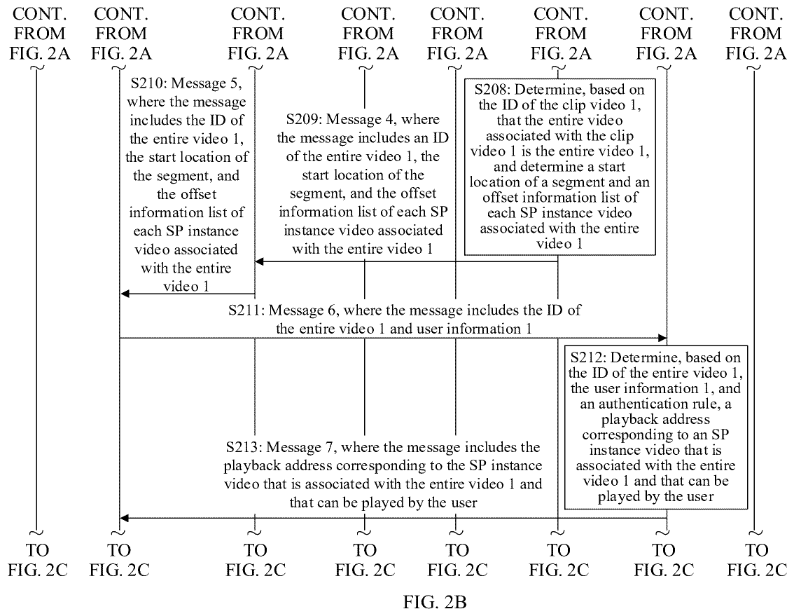

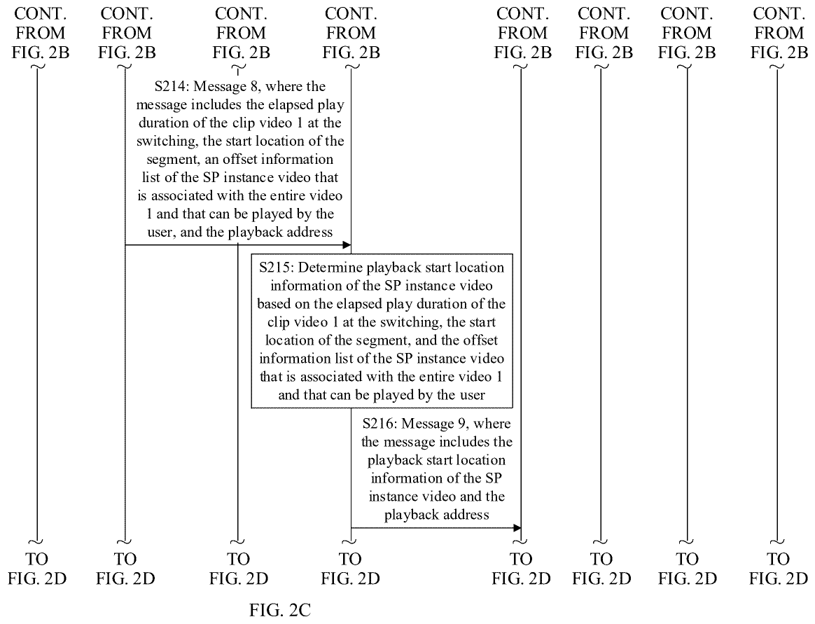

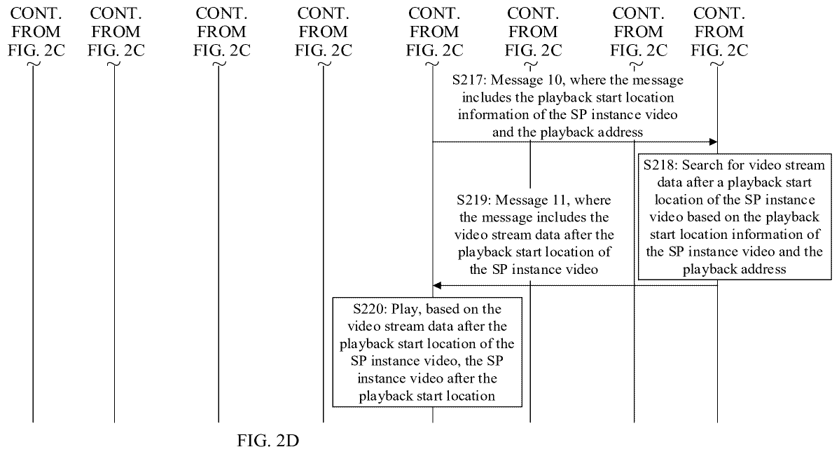

FIG. 2A to FIG. 2D show an example of a specific procedure of a video processing method in a scenario of switching a clip video to an entire video according to an embodiment of this disclosure.

As shown in FIG. 2A to FIG. 2D, the method may be applied to the communication system including the electronic device 100 and the server 200. The electronic device 100 may include a switching instruction receiving module, a playback authentication module, a program information obtaining module, a continuous playback calculation module, and a video playback module. The server 200 may include a program data management service module, a playback authentication service module, and a streaming media service module. The following describes in detail specific steps of the method.

S201: The program data management service module of the server 200 maintains program metadata.

Further, in a process of distributing a program on an online platform, operation personnel may maintain program metadata (or program information) of a clip video and an entire video through the program data management service module of the server 200.

Maintaining the program metadata of the clip video and the entire video by the operation personnel mainly includes recording metadata of the clip video (for example, an identifier (ID) of the clip video), recording an association relationship between the clip video and the entire video (for example, an association relationship between the ID of the clip video and an ID of the entire video), recording editing location information, relative to the basic video, of the clip video (or start location information of a segment), and the like.

In this embodiment of this disclosure, in a process of maintaining the program metadata of the entire video, the operation personnel need to additionally maintain offset information corresponding to a clip inserted or cropped, during operation, for each SP instance video associated with the entire video. The operation personnel may maintain, according to an operation requirement during or after release of each SP instance video, the offset information corresponding to the clip inserted into or cropped from each SP instance video. That is, an offset information list of each SP instance video is additionally recorded in program information of the entire video. The offset information list includes offset information corresponding to a clip inserted (for example, inserted at the beginning or inserted in the middle) or cropped from the SP instance video.

The offset information may include a start location at which a clip is inserted into/cropped from the basic video (an insertion location or a cropping location of the clip inserted into/cropped from the basic video) and offset duration (duration of the inserted or cropped clip).

Offset information corresponding to each inserted/cropped clip may be briefly described as δ(B, L), where B may represent the start location of the clip inserted into/cropped from the basic video, and L may represent the offset duration.

It is easy to understand that, in a case in which the offset duration L is greater than 0, in the SP instance video, a clip is inserted into the basic video, that is, offset duration corresponding to the inserted clip is a positive number, or in a case in which the offset duration L is less than 0, the SP instance video is obtained by cropping a clip from the basic video, that is, offset duration corresponding to the cropped clip is a negative number.

It is assumed that duration of the basic video is 30 minutes. For example, if a start location of a clip inserted into the basic video is 00:00 (a clip inserted at a playback start point of the basic video, which is a beginning-inserted clip) and insertion duration is 10 seconds, offset information of the inserted clip may be represented as δ(00:00, 10). For another example, if a start location of a clip inserted into the basic video is 10:00 (a clip inserted between a playback start point and a playback end point of the basic video, which is a middle-inserted clip) and insertion duration is 10 seconds, offset information of the inserted clip may be represented as δ(10:00, 10). For another example, if a start location of a clip cropped from the basic video is 20:00 and cropping duration is 10 seconds, offset information of an inserted clip may be represented as δ(20:00, −10).

The offset information list of each SP instance video may be briefly described as list <δ(Bi, Li)>, where i may represent a number of the inserted/cropped clip, and i may be a positive integer.

For example, an SP instance video has two inserted clips and one cropped clip, which are an inserted clip 1, an inserted clip 2, and a cropped clip 3 respectively. In this case, offset information of the inserted clip 1 may be represented as δ(B1, L1), offset information of the inserted clip 2 may be represented as δ(B2, L2), offset information of the cropped clip 3 may be represented as δ(B3, L3), and an offset information list of the SP instance video may be represented as {δ(B1, L1), δ(B2, L2), δ(B3, L3)}.

After completing a segmentation operation (an editing operation) of the clip video, the operation personnel may maintain the association relationship between the clip video and the entire video and the editing location information, relative to the basic video, of the clip video while releasing the clip video through the program data management service module of the server 200.

It is easy to understand that, in a process of maintaining the metadata of the clip video, the operation personnel do not need to pay attention to related data in an SP instance video associated with the entire video.

In this embodiment of this disclosure, the basic video may be an original video that is provided by a video distributor, includes complete content of the video, and does not include a clip (for example, an advertisement clip) subsequently inserted by each SP. The clip video may be a video clip obtained by editing a basic video.

S202: The video playback module of the electronic device 100 plays a clip video 1.

Further, a video playback application (for example, a “Huawei video” application) may be installed on the electronic device 100. The switching instruction receiving module, the playback authentication module, the program information obtaining module, the continuous playback calculation module, and the video playback module that are included in the electronic device 100 may be included in the application. The electronic device 100 may play the clip video 1 through the video playback module included in the application.

It is easy to understand that, before playing the clip video 1, the electronic device 100 may obtain a video resource of the clip video 1 from the server 200 in a pre-download or data request manner.

In this embodiment of this disclosure, an example in which the video playback application is a “Huawei video” application is used. This is not limited thereto, and the video playback application may be another application. This is not limited in embodiments of this disclosure.

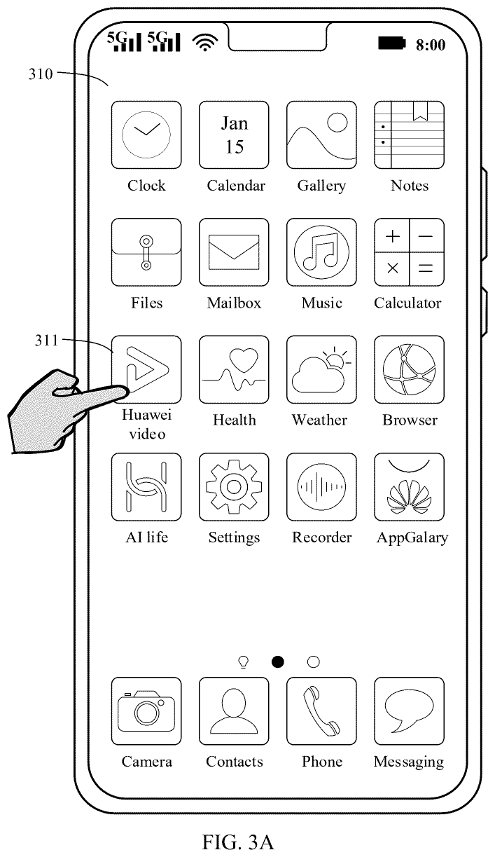

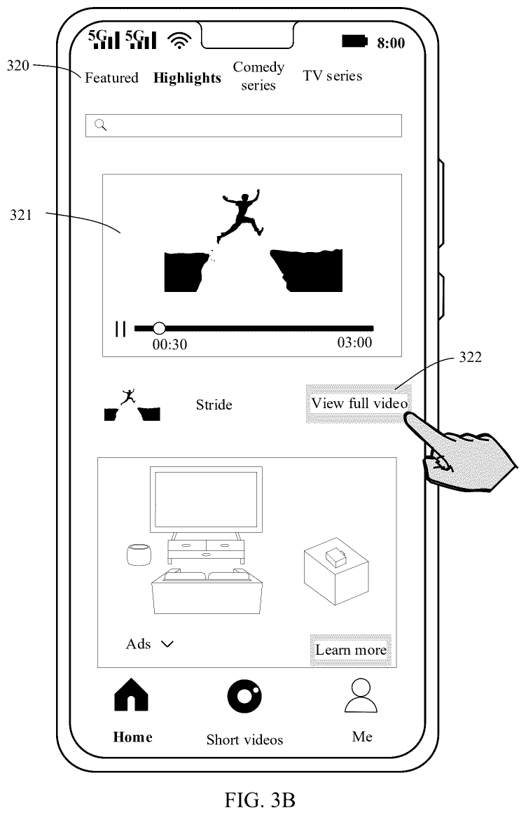

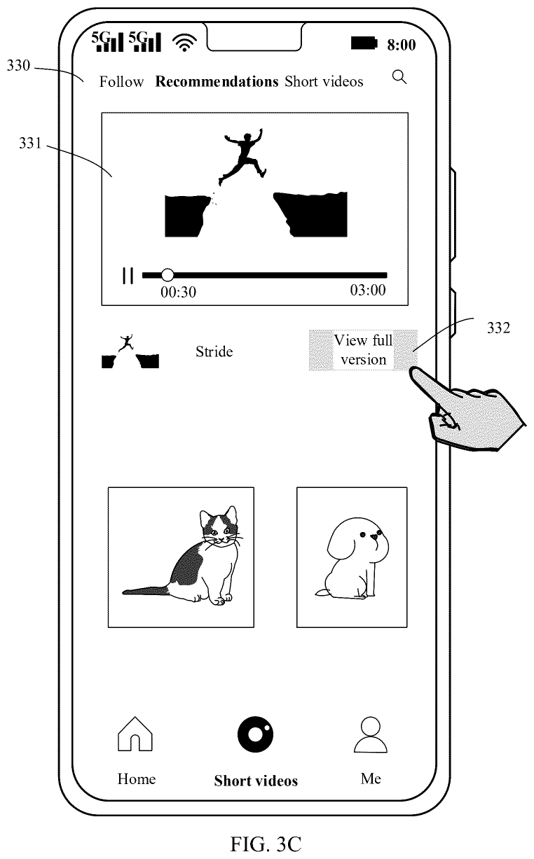

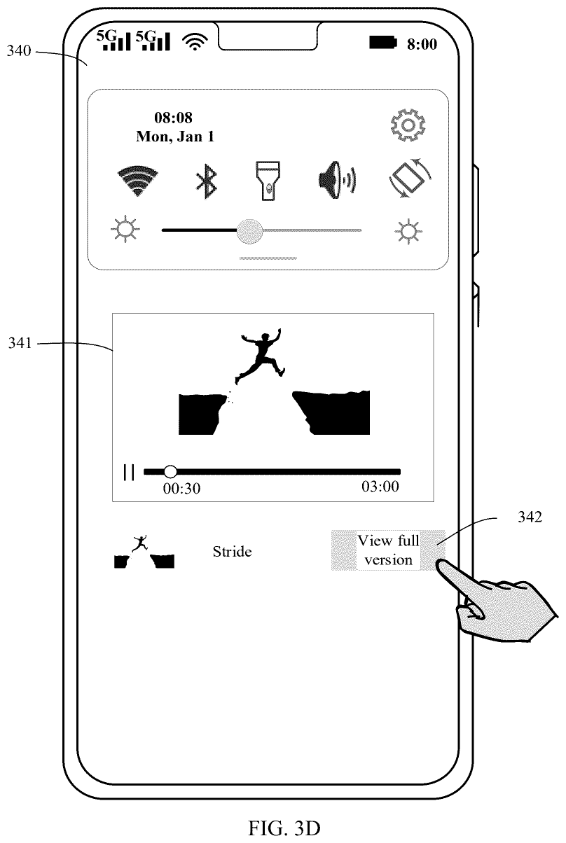

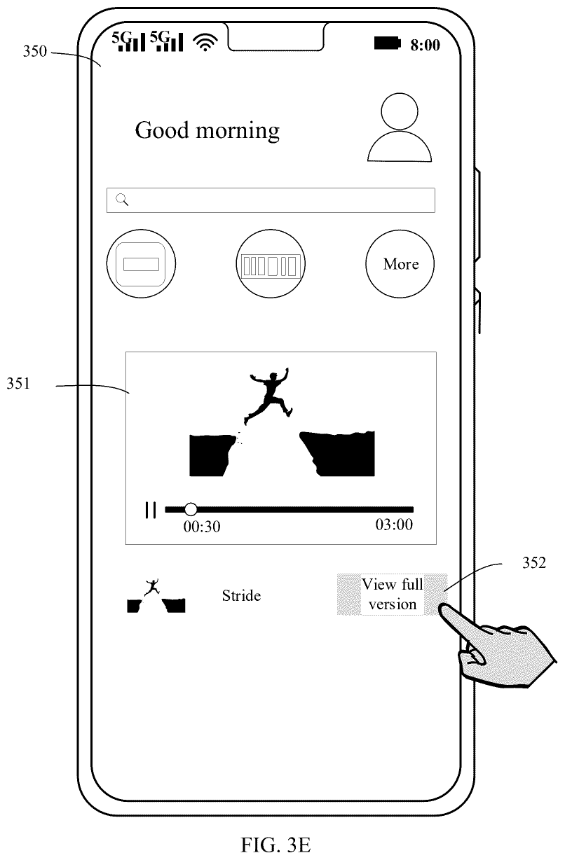

For example, refer to FIG. 3A. FIG. 3A is a user interface 310 provided in a “Desktop” application on the electronic device 100. The user interface may include icons of one or more applications, for example, an icon 311 of a “Huawei video” application. The electronic device 100 may detect an operation (for example, a tap operation) performed by the user on the icon 311 of the “Huawei video” application, and in response to the operation, the electronic device 100 may start the “Huawei video” application.

Refer to FIG. 3B. FIG. 3B may be a user interface 320 corresponding to a “Home” option in the “Huawei video” application. The user interface may include a video playback area 321 and an option 322 (for example, a “View full video” option).

The video playback area 321 may be used to play a clip video.

The option 322 may be used to switch a clip video to an entire video associated with the clip video.

The clip video played in the video playback area 321 may be the clip video 1, and the clip video 1 may be automatically recommended by the “Huawei video” application, or may be actively found by the user in the “Huawei video” application.

Refer to FIG. 3C. FIG. 3C may be a user interface 330 corresponding to a “Short videos” option in the “Huawei video” application. The user interface may include a video playback area 331 and an option 332 (for example, a “View full version” option).

The video playback area 331 may be used to play a clip video.

The option 332 may be used to switch a clip video to an entire video associated with the clip video.

The clip video played in the video playback area 331 may be the clip video 1, and the clip video 1 may be automatically recommended by the “Huawei video” application, or may be actively found by the user in the “Huawei video” application.

Each of the video playback area 321 and the video playback area 331 may further include a video playback progress bar, and the video playback progress bar may display elapsed play duration of a video and total duration of the video. It can be seen from the video playback progress bar that elapsed play duration of the clip video 1 is 30 seconds, and total duration is 3 minutes.

FIG. 3A to FIG. 3C show a process in which the electronic device 100 starts the “Huawei video” application to play the clip video 1, and the electronic device 100 is not limited thereto. The electronic device 100 may further play, in a notification bar or a leftmost screen, the clip video 1 provided by the “Huawei video” application.

Refer to FIG. 3D. FIG. 3D may be a user interface 340 corresponding to a “Notification bar” of the electronic device 100. The user interface may include a video playback area 341 and an option 342 (for example, a “View full version” option). The video playback area 341 may be used to play a clip video. The option 342 may be used to switch a clip video to an entire video associated with the clip video.

Similarly, refer to FIG. 3E. FIG. 3E may be a user interface 350 corresponding to a “Leftmost screen” of the electronic device 100. The user interface may include a video playback area 351 and an option 352 (for example, a “View full version” option). The video playback area 351 may be used to play a clip video. The option 352 may be used to switch a clip video to an entire video associated with the clip video.

It may be understood that the electronic device 100 may directly play a clip video in an application, a notification bar, or a leftmost screen, without a need for the user to trigger playback of the clip video before playing the clip video, or the electronic device 100 may first display an image in the clip video, and play the clip video after the user triggers playback of the clip video.

S203-S204: The video playback module of the electronic device 100 detects an operation of switching, by the user, to play an entire video (an entire video 1) associated with the clip video 1, and in response to the operation, the video playback module of the electronic device 100 sends a switching instruction to the switching instruction receiving module of the electronic device 100, where the instruction includes an ID of the clip video 1 and elapsed play duration of the clip video 1 at switching.

Further, during playback of the clip video 1 through the video playback module of the electronic device 100, if the user wants to switch to the entire video associated with the clip video 1 (that is, the user wants to play, through the video playback module of the electronic device 100, the entire video associated with the clip video 1), the video playback module of the electronic device 100 may detect the operation of switching, by the user, to play the entire video (the entire video 1) associated with the clip video 1, and in response to the operation, the video playback module of the electronic device 100 may send a switching instruction to the switching instruction receiving module of the electronic device 100. The instruction includes the ID of the clip video 1 and the elapsed play duration of the clip video 1 at the switching.

The “operation of switching, by the user, to play the entire video associated with the clip video 1” may be an operation (for example, a tap operation) performed by the user on the option 322 or the video playback area 321 shown in FIG. 3B as an example, or an operation (for example, a tap operation) performed by the user on the option 332 or the video playback area 331 shown in FIG. 3C as an example, or an operation (for example, a tap operation) performed by the user on the option 342 shown in FIG. 3D as an example, or an operation (for example, a tap operation) performed by the user on the option 352 shown in FIG. 3E as an example.

It is easy to understand that the ID of the clip video is obtained by the electronic device 100 from the server 200.

In this embodiment of this disclosure, the ID of the clip video 1 and the elapsed play duration of the clip video 1 at the switching may be included in the switching instruction, or may not be included in the switching instruction, but are separately sent by the video playback module. This is not limited herein.

After receiving the switching instruction sent by the video playback module, the switching instruction receiving module of the electronic device 100 may invoke the playback authentication module of the electronic device 100 to perform playback authentication on the entire video. Further, the playback authentication module of the electronic device 100 may invoke, according to the switching instruction received by the switching instruction receiving module, the program information obtaining module of the electronic device 100 to query information about the entire video that needs to be authenticated. Further, the program information obtaining module of the electronic device 100 may invoke, based on the ID of the clip video 1 included in the switching instruction, the program data management service module of the server 200 to query information about the entire video that needs to be authenticated. A possible implementation of the foregoing process may be an implementation described in the following steps S205 to S207.

S205-S207: The switching instruction receiving module of the electronic device 100 sends a message 1 to the playback authentication module of the electronic device 100, where the message may include the ID of the clip video 1 and the elapsed play duration of the clip video 1 at the switching. After receiving the message 1, the playback authentication module of the electronic device 100 may send a message 2 to the program information obtaining module of the electronic device 100, where the message may include the ID of the clip video 1. After receiving the message 2, the program information obtaining module of the electronic device 100 may send a message 3 to the program data management service module of the server 200, where the message may include the ID of the clip video 1.

S208: The program data management service module of the server 200 determines, based on the ID of the clip video 1, that the entire video associated with the clip video 1 is the entire video 1, and determines a start location of a segment and an offset information list of each SP instance video associated with the entire video 1.

Further, after the program data management service module of the server 200 receives the message 3 sent by the program information obtaining module of the electronic device 100, because the program data management service module of the server 200 has recorded the association relationship between the clip video and the entire video in the process of maintaining the program metadata in step S201, the program data management service module of the server 200 may query, based on the ID of the clip video 1 included in the message, the entire video associated with the clip video 1.

The entire video associated with the clip video 1 may be a basic video from which the clip video 1 is obtained through editing. It is assumed that the entire video associated with the clip video 1 is the entire video 1.

Further, after it is determined that the entire video associated with the clip video 1 is the entire video 1, because the program data management service module of the server 200 further records, in the process of maintaining the program metadata in step S201, the editing location information, relative to the basic video, of the clip video, and the offset information corresponding to the clip inserted or cropped, during operation, for each SP instance video associated with the entire video, the program data management service module of the server 200 may further determine the start location of the segment and the offset information list of each SP instance video associated with the entire video 1.

S209: The program data management service module of the server 200 sends a message 4 to the program information obtaining module of the electronic device 100, where the message includes an ID of the entire video 1, the start location of the segment, and the offset information list of each SP instance video associated with the entire video 1.

Further, after performing the foregoing step S208, the program data management service module of the server 200 may send the message 4 to the program information obtaining module of the electronic device 100.

S210: The program information obtaining module of the electronic device 100 sends a message 5 to the playback authentication module of the electronic device 100, where the message includes the ID of the entire video 1, the start location of the segment, and the offset information list of each SP instance video associated with the entire video 1.

Further, after receiving the message 4 sent by the program data management service module of the server 200, the program information obtaining module of the electronic device 100 may send the message 5 to the playback authentication module of the electronic device 100.

S211: The playback authentication module of the electronic device 100 sends a message 6 to the playback authentication service module of the server 200, where the message includes the ID of the entire video 1 and user information 1.

Further, after receiving the message 5 sent by the program information obtaining module of the electronic device 100, the playback authentication module of the electronic device 100 may send the message 6 to the playback authentication service module of the server 200.

The user information 1 may be account information used by the user to log in to a video playback application (for example, a “Huawei video” application). The account information may include but is not limited to a mobile number, an email address, a user-defined user name, and the like.

In some examples, the user information 1 may alternatively be sent in step S207. In this case, the playback authentication module of the electronic device 100 does not need to perform step S211, and the program data management service module of the server 200 does not need to send the ID of the entire video 1 to the playback authentication module of the electronic device 100 in step S209, but may directly send the ID of the entire video 1 to the playback authentication service module of the server 200, to perform the subsequent step S212. In this case, step S208 “determining a start location of a segment and an offset information list of each SP instance video associated with the entire video 1” may alternatively be performed after step S212.

S212: The playback authentication service module of the server 200 determines, based on the ID of the entire video 1, the user information 1, and an authentication rule, a playback address corresponding to an SP instance video that is associated with the entire video 1 and that can be played by the user.

The authentication rule may be preset, and may be used to determine whether the user has permission to play an SP instance video.

Further, the playback authentication service module of the server 200 may first find, based on the ID of the entire video 1, playback addresses corresponding to all SP instance videos associated with the entire video 1, and further determine, in the playback addresses corresponding to all SP instance videos based on the user information 1 and the authentication rule, a playback address corresponding to an SP instance video that can be played by the user (that is, the user has permission to play).

For example, it is assumed that the authentication rule specifies that, for an SP instance video associated with the entire video 1, only a user who subscribes to a membership of the SP has permission to play the SP instance video. If it is determined based on the user information 1 that the user is a member user of the SP, it may be further determined that the user can play the SP instance video, or if it is determined that the user is a non-member user of the SP, it may be further determined that the user cannot play the SP instance video.

It may be understood that a quantity of SP instance videos that is associated with the entire video 1 and that can be played by the user may be 0, in which case no SP instance video can be played, or may be 1, in which case only this one SP instance video can be played, or may be two or more, in which case one of the two or more SP instance videos can be played according to a preset operation strategy. For example, there are two SP instance videos that are associated with the entire video 1 and that can be played by the user, and the two SP instance videos are provided by an SP “Huawei video” and another SP respectively. If the SP “Huawei video” takes precedence over the other SP according to the preset operation strategy, the electronic device 100 plays the SP instance video provided by the SP “Huawei video”, otherwise, the electronic device 100 plays the SP instance video provided by another SP.

S213: The playback authentication service module of the server 200 sends a message 7 to the playback authentication module of the electronic device 100, where the message includes the playback address corresponding to the SP instance video that is associated with the entire video 1 and that can be played by the user.

Further, after performing the foregoing step S212, the playback authentication service module of the server 200 may send the message 7 to the playback authentication module of the electronic device 100.

S214: The playback authentication module of the electronic device 100 sends a message 8 to the continuous playback calculation module of the electronic device 100, where the message includes the elapsed play duration of the clip video 1 at the switching, the start location of the segment, an offset information list of the SP instance video that is associated with the entire video 1 and that can be played by the user, and the playback address.

Further, after receiving the message 7 sent by the playback authentication service module of the server 200, the playback authentication module of the electronic device 100 may send the message 8 to the continuous playback calculation module of the electronic device 100. The message 8 indicates the continuous playback calculation module to calculate playback start location information of the SP instance video that is associated with the entire video 1 and that can be played by the user.

S215: The continuous playback calculation module of the electronic device 100 determines the playback start location information of the SP instance video based on the elapsed play duration of the clip video 1 at the switching, the start location of the segment, and the offset information list of the SP instance video that is associated with the entire video 1 and that can be played by the user.

Further, after receiving the message 8 sent by the playback authentication module of the electronic device 100, the continuous playback calculation module of the electronic device 100 may determine the playback start location information of the SP instance video based on the offset information list of the SP instance video that is associated with the entire video 1 and that can be played by the user, the elapsed play duration of the clip video 1 at the switching, and the start location of the segment that are included in the message.

The following describes in detail a specific process that “the continuous playback calculation module of the electronic device 100 determines the playback start location information of the SP instance video based on the elapsed play duration of the clip video 1 at the switching, the start location of the segment, and the offset information list of the SP instance video that is associated with the entire video 1 and that can be played by the user”.

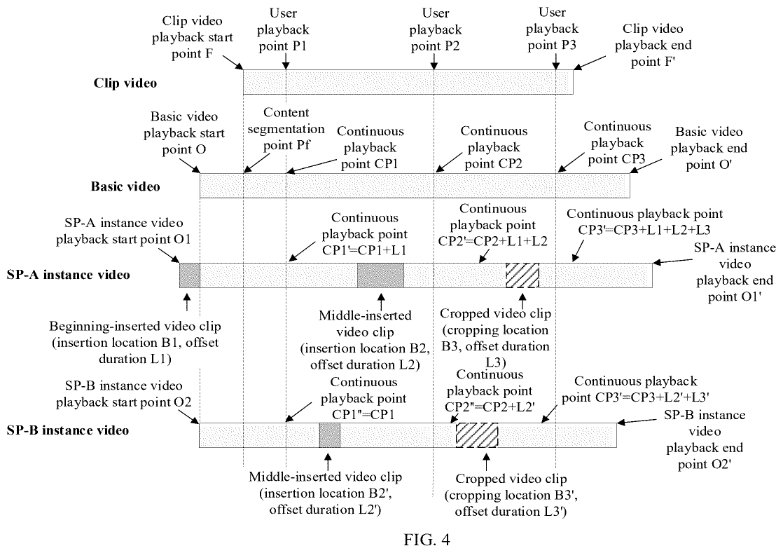

For example, refer to FIG. 4. FIG. 4 is a principle diagram of performing continuous playback calculation in a scenario of “switching a clip video to an entire video” according to an embodiment of this disclosure.

It is assumed that a clip video shown in FIG. 4 is the clip video 1, a basic video is the entire video 1 (a video from which the clip video 1 is obtained through editing), an SP-A instance video is an SP instance video that is associated with the entire video 1 and that can be played by the user, and an SP-B instance video is another SP instance video that is associated with the entire video 1 and that can be played by the user. The SP-A instance video and the SP-B instance video are obtained by inserting some clips into/cropping some clips from the basic video by corresponding SPs due to an operation reason.

The “elapsed play duration of the clip video 1 at switching” may be determined based on a user playback point Pi (a time point of a playback progress of the clip video 1 in a case in which the user performs a switching action), where i is a positive integer. For example, if the user playback point Pi is 00:30, the elapsed play duration of the clip video 1 at the switching is 30 seconds.

The “start location of the segment” may be determined based on a location, relative to a timeline location of the basic video, of a playback start point F of the clip video. The start location of the segment is recorded when the clip video starts to be edited. It can be seen that a location of the playback start point F of the clip video is a playback start location of the clip video, and the location, relative to the timeline location of the basic video, of the playback start point F of the clip video is a location of a content segmentation point Pf (the start location of the segment). That is, the clip video starts to be edited at the location of the content segmentation point Pf, and a length of the clip video (duration of the clip video) is a time difference between a playback end point F′ of the clip video and the playback start point F of the clip video. The duration of the basic video is a time difference between a playback end point O′ of the basic video and a playback start point O of the basic video.

The “offset information list of the SP instance video that is associated with the entire video 1 and that can be played by the user” may be determined based on a start location of the clip inserted into/cropped from the basic video and offset duration. The offset information list of the SP instance video that is associated with the entire video 1 and that can be played by the user is recorded in the process of maintaining the program metadata. The SP-A instance video is used as an example. It can be seen that the SP-A instance video is obtained by inserting two clips (a beginning-inserted video clip and a middle-inserted video clip) into the basic video and cropping a clip (a cropped video clip) from the basic video. An insertion location of the beginning-inserted video clip is B1 and offset duration is L1. An insertion location of the middle-inserted video clip is B2 and offset duration is L2. A cropping location of the cropped video clip is B3 and offset duration is L3. Therefore, an offset information list of the SP-A instance video may be represented as {δ(B1, L1 ), δ(B2, L2), δ(B3, L3)}. Duration of the SP-A instance video is a time difference between a playback end point O1′ of the SP-A instance video and a playback start point O1 of the SP-A instance video.

The continuous playback calculation module may first determine a continuous playback point of the basic video based on the elapsed play duration of the clip video 1 at the switching and the start location of the segment, and then determine a continuous playback point of the SP-A instance video (playback start location information of the SP-A instance video) based on the continuous playback point of the basic video and the offset information list of the SP-A instance video.

It is easy to understand that the continuous playback point of the basic video is determined by adding the elapsed play duration of the clip video 1 at the switching and the start location of the segment. For example, it is assumed that elapsed play duration Lf of the clip video 1 at switching is 30 seconds, and a start location Pf of the segment is 10:00. In this case, a continuous playback point CP of the basic video is CP=Pf+Lf=10:30.

After the continuous playback point of the basic video is determined, first, it needs to be determined whether a clip is inserted into/cropped from the SP-A instance video before a location of the continuous playback point of the basic video. If a clip is inserted/cropped, the continuous playback point of the SP-A instance video is a point obtained by adding up the continuous playback point of the basic video and offset duration of all clips inserted/cropped before the location of the continuous playback point of the basic video. If no clip is inserted/cropped, the continuous playback point of the SP-A instance video is the continuous playback point of the basic video.

To be specific, it is assumed that the continuous playback point of the basic video is CP. In this case, a continuous playback point CP′ of the SP-A instance video is CP′=CP+Σᵢ₌₁ⁿLᵢ, where n is a total quantity of clips inserted and cropped before the location of the continuous playback point of the basic video, and Lᵢ is offset duration of an i^{th} clip inserted/cropped before the location of the continuous playback point of the basic video.

For example, refer to FIG. 4. A continuous playback point, corresponding to a user playback point P1, of the basic video is CP1. It can be seen that a clip (a beginning-inserted video clip) is inserted into the SP-A instance video before a location of CP1. In this case, a continuous playback point of the SP-A instance video is CP1′=CP1+L1. A continuous playback point, corresponding to a user playback point P2, of the basic video is CP2. It can be seen that two clips (a beginning-inserted video clip and a middle-inserted video clip) are inserted into the SP-A instance video before a location of CP2. In this case, a continuous playback point of the SP-A instance video is CP2′=CP2+L1+L2. A continuous playback point, corresponding to a user playback point P3, of the basic video is CP3. It can be seen that two clips (a beginning-inserted video clip and a middle-inserted video clip) are inserted into the SP-A instance video before a location of CP3 and one clip (a cropped video clip) is cropped. In this case, a continuous playback point of the SP-A instance video is CP3′=CP3+L1+L2+L3. It is easy to understand that offset duration of the inserted clip is a positive number, and offset duration of the cropped clip is a negative number.

A process of “determining whether a clip is inserted into/cropped from the SP-A instance video before a location of the continuous playback point of the basic video” is as follows: If an insertion location or a cropping location, of the clip inserted into/cropped from the basic video, recorded in the offset information list of the SP-A instance video is before the location of the continuous playback point of the basic video, it is determined that a clip is inserted/cropped for the SP-A instance video before the location of the continuous playback point of the basic video.

It is easy to understand that, that the clip is inserted into/cropped from the SP-A instance video before the location of the continuous playback point of the basic video means that the clip is inserted/cropped for the SP-A instance video before the location of the continuous playback point, and that no clip is inserted/cropped for the SP-A instance video before the location of the continuous playback point of the basic video means that no clip is inserted/cropped for the SP-A instance video before the location of the continuous playback point.

The foregoing merely describes calculation of a continuous playback point of the SP instance video by using an example in which “the SP instance video that is associated with the entire video 1 and that can be played by the user is an SP-A instance video”. It is easy to understand that, when the SP instance video that is associated with the entire video 1 and that can be played by the user is a plurality of different SP instance videos, a continuous playback point of each SP instance video may be calculated in the foregoing manner. In this way, when the user switches to a different SP instance video, a corresponding continuous playback point can be accurately located, to ensure continuity of video playback.

Refer to FIG. 4. An offset information list of the SP-B instance video may be represented as {δ(B2′, L2′), δ(B3′, L3′)}. Duration of the SP-B instance video is a time difference between a playback end point O2′ of the SP-B instance video and a playback start point O2 of the SP-B instance video. Similarly, according to the foregoing manner of calculating the SP instance video, it is easy to understand that, when a user playback point is P1, a continuous playback point of the SP-B instance video is CP1″=CP1, when a user playback point is P2, a continuous playback point of the SP-B instance video is CP2″=CP2+L2′, or when a user playback point is P3, a continuous playback point of the SP-B instance video is CP3″=CP3+L2′+L3′.

It is easy to understand that the clip video 1 is a video clip obtained by editing the basic video, and is also a video clip in “the SP instance video associated with the entire video 1”.

S216: The continuous playback calculation module of the electronic device 100 sends a message 9 to the video playback module of the electronic device 100, where the message includes the playback start location information of the SP instance video and the playback address.

Further, after performing the foregoing step S215, the continuous playback calculation module of the electronic device 100 may send the message 9 to the video playback module of the electronic device 100. The message 9 indicates the video playback module of the electronic device 100 to obtain video stream data after a playback start location of the SP instance video.

S217: The video playback module of the electronic device 100 sends a message 10 to the streaming media service module of the server 200, where the message includes the playback start location information of the SP instance video and the playback address.

Further, after receiving the message 9 sent by the continuous playback calculation module of the electronic device 100, the video playback module of the electronic device 100 may send the message 10 to the streaming media service module of the server 200, so as to obtain the video stream data after the playback start location of the SP instance video from the streaming media service module of the server 200.

S218-S220: The streaming media service module of the server 200 searches for the video stream data after the playback start location of the SP instance video based on the playback start location information of the SP instance video and the playback address. Then, the streaming media service module of the server 200 may send a message 11 to the video playback module of the electronic device 100, where the message includes the video stream data after the playback start location of the SP instance video. Then, the video playback module of the electronic device 100 may play, based on the video stream data after the playback start location of the SP instance video, the SP instance video after the playback start location.

For example, it is assumed that elapsed play duration Lf of the clip video 1 at switching is 30 seconds, and a start location Pf of the segment is 10:00. In this case, a continuous playback point CP of the basic video is CP=Pf+Lf=10:30, and a continuous playback point CP′ of the SP instance video (the playback start location information of the SP instance video) is CP′=CP+Σᵢ₌₁ⁿLᵢ, where n is a total quantity of clips inserted and cropped before the location of the continuous playback point of the basic video, and Lᵢ is offset duration of an i^{th} clip inserted/cropped before the location of the continuous playback point of the basic video.

1. In a case in which Σᵢ₌₁ⁿLᵢ is 0 (in a case in which the total quantity of clips inserted and cropped before the location of the continuous playback point of the basic video is 0, or a sum of offset duration of all clips inserted and cropped before the location of the continuous playback point of the basic video is 0), the continuous playback point CP′ of the SP instance video is the same as the continuous playback point CP of the basic video, namely, 10:30.

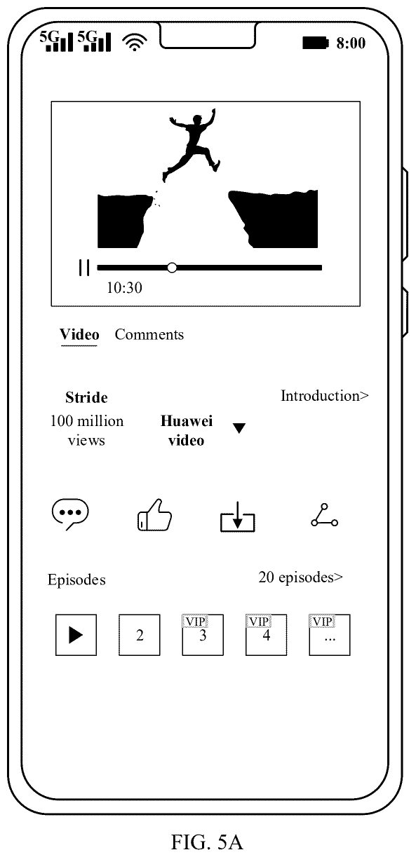

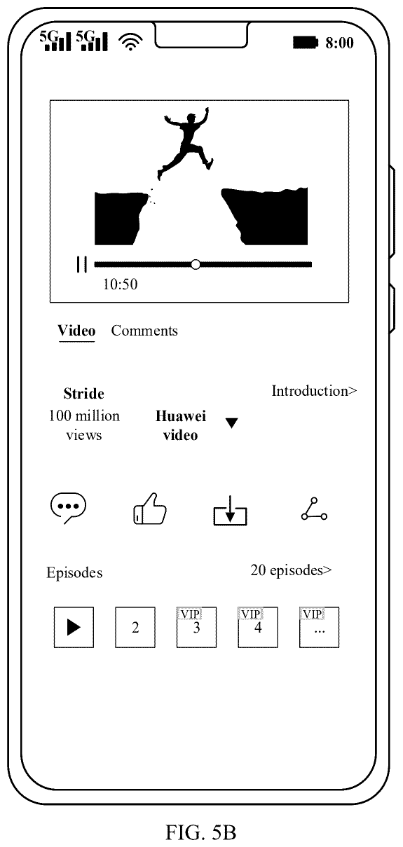

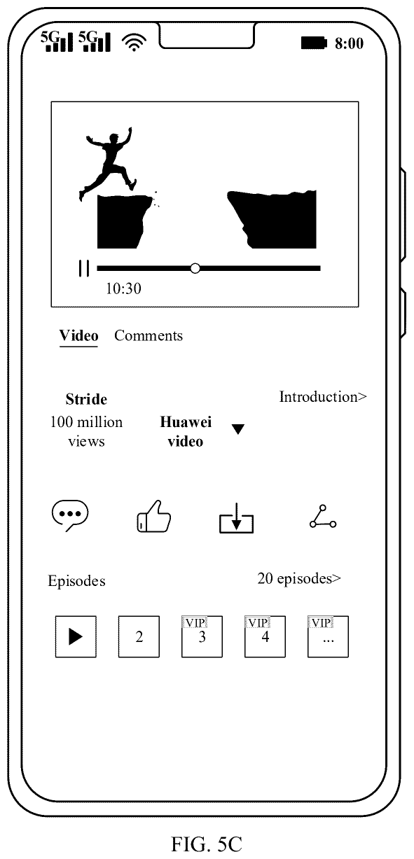

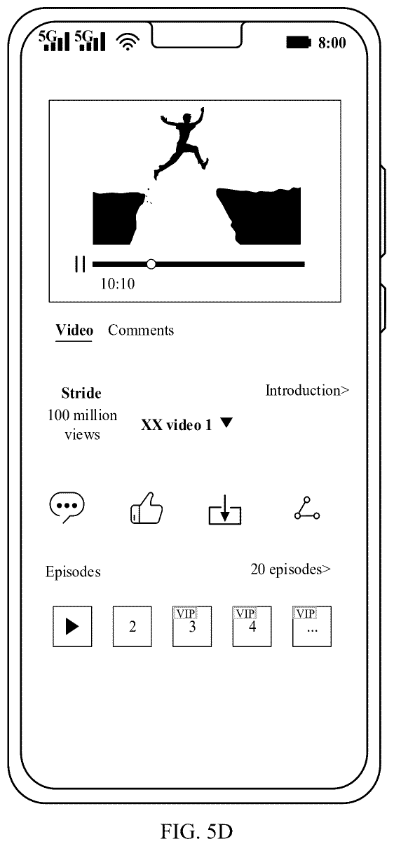

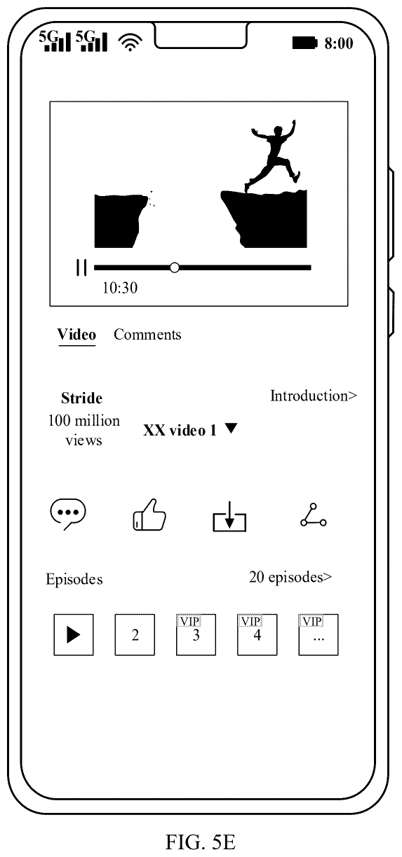

For example, refer to FIG. 5A. A user interface shown in FIG. 5A may be a user interface displayed when the user continues to play an SP instance video after performing a switching operation. For example, the SP instance video may be an instance video provided by the SP “Huawei video”. It can be learned that a playback start location of the SP instance video (a continuous playback point of the SP instance video) is 10:30, in other words, a location, of an image played in the clip video 1 when the user performs the switching operation, in the SP instance video is 10:30. Further, the electronic device 100 may continue to play, at 10:30 based on the obtained video stream data after the playback start location of the SP instance video, the SP instance video after the playback start location.

2. In a case in which Σᵢ₌₁ⁿLᵢ is not 0 (in a case in which the total quantity of clips inserted/cropped before the location of the continuous playback point of the basic video is not 0, and a sum of offset duration of all clips inserted and cropped before the location of the continuous playback point of the basic video is not 0), the continuous playback point CP′ of the SP instance video is different from the continuous playback point CP of the basic video.

It is assumed that Σᵢ₌₁ⁿLᵢ is 20 seconds and the continuous playback point CP of the basic video is still 10:30 in a case in which Σᵢ₌₁ⁿLᵢ is greater than 0. In this case, the continuous playback point CP′ of the SP instance video is CP′=10:30+20=10:50.

For example, refer to FIG. 5B. A user interface shown in FIG. 5B may be a user interface displayed when the user continues to play an SP instance video after performing a switching operation. For example, the SP instance video may be an instance video provided by the SP “Huawei video”. It can be learned that a playback start location of the SP instance video (a continuous playback point of the SP instance video) is 10:50, in other words, a location, of an image played in the clip video 1 when the user performs the switching operation, in the SP instance video is 10:50. Further, the electronic device 100 may continue to play, at 10:50 based on the obtained video stream data after the playback start location of the SP instance video, the SP instance video after the playback start location.

It is easy to understand that, in the case in which Σᵢ₌₁ⁿLᵢ is not 0, if offset duration of the inserted/cropped clip is not added during calculation of the continuous playback point of the SP instance video, the calculated continuous playback point of the SP instance video is the same as the continuous playback point of the basic video and is still 10:30. In this case, a continuous playback start image is an image corresponding to 10:30 in the SP instance video (for example, an image shown in FIG. 5C). Therefore, it is necessary to continue playing for 20 seconds to display an image played in the clip video 1 when the user performs the switching operation (for example, an image corresponding to 10:50 in the SP instance video shown in FIG. 5B). This cannot implement continuity of video playback before and after switching, resulting in poor user experience.

The foregoing describes the case in which Σᵢ₌₁ⁿLᵢ is greater than 0 by using an example in which the SP instance video is an instance video provided by the SP “Huawei video”. The following describes a case in which Σᵢ₌₁ⁿLᵢ is less than 0 by using an example in which the SP instance video is an instance video provided by an SP “XX video 1”.

It is assumed that Σᵢ₌₁ⁿLᵢ is −20 seconds and the continuous playback point CP of the basic video is still 10:30. In this case, the continuous playback point CP′ of the SP instance video is CP′=10:30−20=10:10.

For example, refer to FIG. 5D. A user interface shown in FIG. 5D may be a user interface displayed when the user continues to play an SP instance video after performing a switching operation. For example, the SP instance video may be an instance video provided by the SP “XX video 1”. It can be learned that a playback start location of the SP instance video (a continuous playback point of the SP instance video) is 10:10, in other words, a location, of an image played in the clip video 1 when the user performs the switching operation, in the SP instance video is 10:10. Further, the electronic device 100 may continue to play, at 10:10 based on the obtained video stream data after the playback start location of the SP instance video, the SP instance video after the playback start location.

It is easy to understand that, in the case in which Σᵢ₌₁ⁿLᵢ is less than 0, if offset duration of the inserted/cropped clip is not added during calculation of the continuous playback point of the SP instance video, the calculated continuous playback point of the SP instance video is the same as the continuous playback point of the basic video and is still 10:30. In this case, a continuous playback start image is an image corresponding to 10:30 in the SP instance video (for example, an image shown in FIG. 5E), and is inconsistent with an image played in the clip video 1 when the user performs the switching operation. This cannot implement continuity of video playback before and after switching, resulting in poor user experience.

Scenario 1: switching a clip video to an entire video:

The following describes a specific execution process of a video processing method provided in an embodiment of this disclosure in a scenario of switching a clip video to an entire video.

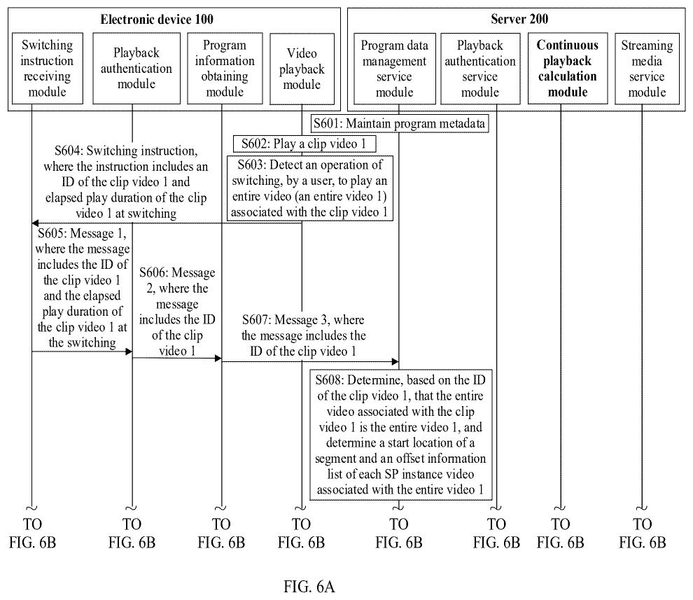

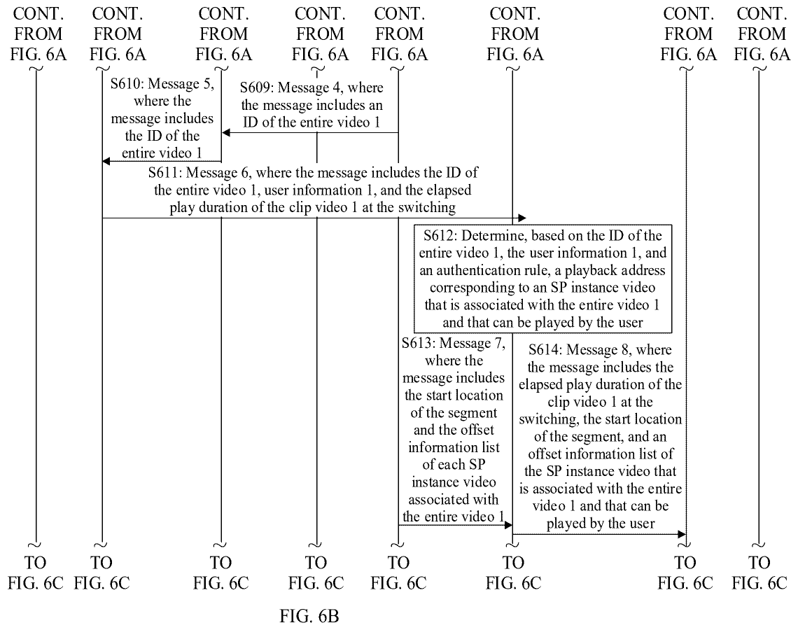

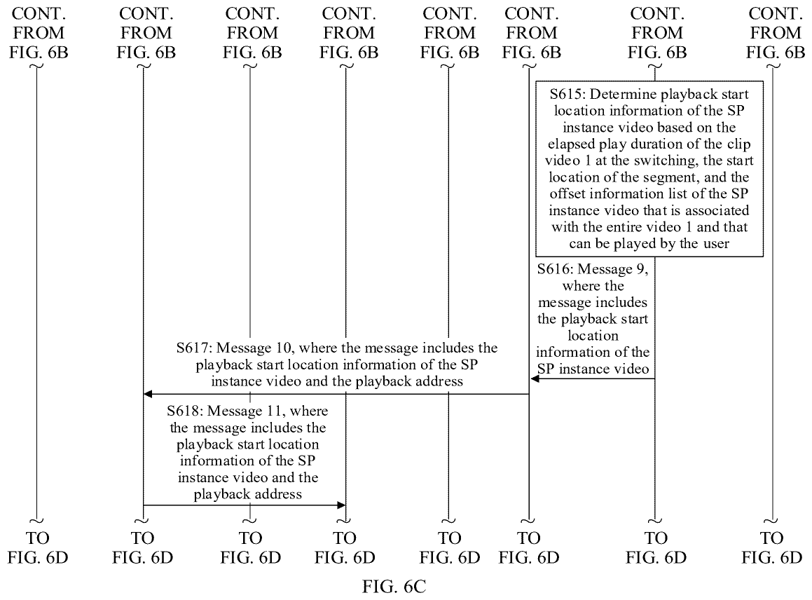

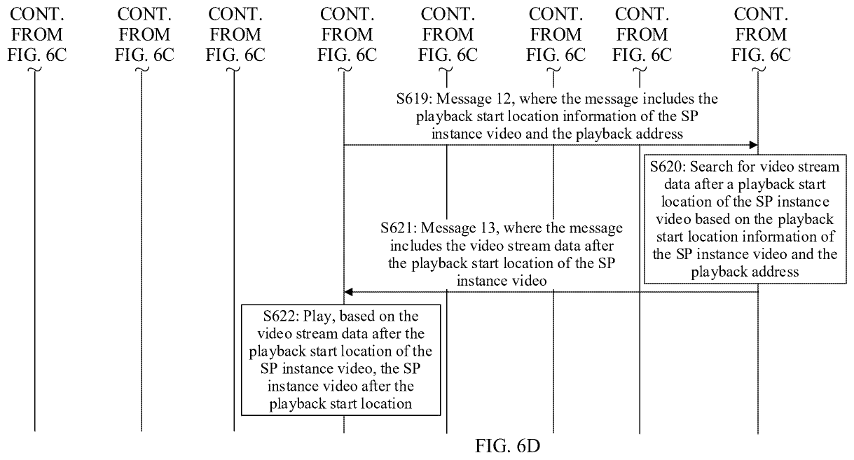

FIG. 6A to FIG. 6D show an example of a specific procedure of another video processing method in a scenario of switching a clip video to an entire video according to an embodiment of this disclosure.

As shown in FIG. 6A to FIG. 6D, the method may be applied to the communication system including the electronic device 100 and the server 200. The electronic device 100 may include a switching instruction receiving module, a playback authentication module, a program information obtaining module, and a video playback module. The server 200 may include a program data management service module, a playback authentication service module, a continuous playback calculation module, and a streaming media service module. Different from the continuous playback calculation module in FIG. 2A, the continuous playback calculation module in FIG. 6A is included in the server 200 instead of the electronic device 100. The following describes in detail specific steps of the method.

S601: The program data management service module of the server 200 maintains program metadata.

S602: The video playback module of the electronic device 100 plays a clip video 1.

S603-S604: The video playback module of the electronic device 100 detects an operation of switching, by the user, to play an entire video (e.g., an entire video 1) associated with the clip video 1, and in response to the operation, the video playback module of the electronic device 100 sends a switching instruction to the switching instruction receiving module of the electronic device 100, where the instruction includes an ID of the clip video 1 and elapsed play duration of the clip video 1 at switching.

S605-S607: The switching instruction receiving module of the electronic device 100 sends a message 1 to the playback authentication module of the electronic device 100, where the message may include the ID of the clip video 1 and the elapsed play duration of the clip video 1 at the switching. After receiving the message 1, the playback authentication module of the electronic device 100 may send a message 2 to the program information obtaining module of the electronic device 100, where the message may include the ID of the clip video 1. After receiving the message 2, the program information obtaining module of the electronic device 100 may send a message 3 to the program data management service module of the server 200, where the message may include the ID of the clip video 1.

S608: The program data management service module of the server 200 determines, based on the ID of the clip video 1, that the entire video associated with the clip video 1 is the entire video 1, and determines a start location of a segment and an offset information list of each SP instance video associated with the entire video 1.

Step S601 to step S608 are similar to step S201 to step S208 shown in FIG. 2A and FIG. 2B. For a specific execution process, refer to related content of step S201 to step S208 shown in FIG. 2A and FIG. 2B. Details are not described herein again.

S609: The program data management service module of the server 200 sends a message 4 to the program information obtaining module of the electronic device 100, where the message includes an ID of the entire video 1.

Further, after performing the foregoing step S608, the program data management service module of the server 200 may send the message 4 to the program information obtaining module of the electronic device 100.

S610: The program information obtaining module of the electronic device 100 sends a message 5 to the playback authentication module of the electronic device 100, where the message includes the ID of the entire video 1.

Further, after receiving the message 4 sent by the program data management service module of the server 200, the program information obtaining module of the electronic device 100 may send the message 5 to the playback authentication module of the electronic device 100.

S611: The playback authentication module of the electronic device 100 sends a message 6 to the playback authentication service module of the server 200, where the message includes the ID of the entire video 1, user information 1, and the elapsed play duration of the clip video 1 at the switching.

Further, after receiving the message 5 sent by the program information obtaining module of the electronic device 100, the playback authentication module of the electronic device 100 may send the message 6 to the playback authentication service module of the server 200.

The user information 1 may be account information used by the user to log in to one or more video playback applications (for example, a “Huawei video” application). The account information may include but is not limited to a mobile number, an email address, a user-defined user name, and the like.

S612: The playback authentication service module of the server 200 determines, based on the ID of the entire video 1, the user information 1, and an authentication rule, a playback address corresponding to an SP instance video that is associated with the entire video 1 and that can be played by the user.

Step S612 is similar to step S212 shown in FIG. 2B. For a specific execution process, refer to related content of step S212 shown in FIG. 2B. Details are not described herein again.

S613: The program data management service module of the server 200 sends a message 7 to the playback authentication service module of the server 200, where the message includes the start location of the segment and the offset information list of each SP instance video associated with the entire video 1.

Step S613 may be performed after step S608 is performed, or may be performed in a process of performing step S609 to step S612. An execution order of step S613 is not limited in embodiments of this disclosure.

S614: The playback authentication service module of the server 200 sends a message 8 to the continuous playback calculation module of the server 200, where the message includes the elapsed play duration of the clip video 1 at the switching, the start location of the segment, and an offset information list of each SP instance video that is associated with the entire video 1 and that can be played by the user.

S615: The continuous playback calculation module of the server 200 determines playback start location information of the SP instance video based on the elapsed play duration of the clip video 1 at the switching, the start location of the segment, and the offset information list of the SP instance video that is associated with the entire video 1 and that can be played by the user.

Step S615 is similar to step S215 shown in FIG. 2C. For a specific execution process, refer to related content of step S215 shown in FIG. 2C. Details are not described herein again.

S616: The continuous playback calculation module of the server 200 sends a message 9 to the playback authentication service module of the server 200, where the message includes the playback start location information of the SP instance video.

Further, after performing the foregoing step S615, the continuous playback calculation module of the server 200 may send the message 9 to the playback authentication service module of the server 200.

S617: The playback authentication service module of the server 200 sends a message 10 to the playback authentication module of the electronic device 100, where the message includes the playback start location information of the SP instance video and the playback address.

Further, after receiving the message 9 sent by the continuous playback calculation module of the server 200, the playback authentication service module of the server 200 may send the message 10 to the playback authentication module of the electronic device 100.

S618: The playback authentication module of the electronic device 100 sends a message 11 to the video playback module of the electronic device 100, where the message includes the playback start location information of the SP instance video and the playback address.

Further, after receiving the message 10 sent by the playback authentication service module of the server 200, the playback authentication module of the electronic device 100 may send the message 11 to the video playback module of the electronic device 100. The message 11 indicates the video playback module of the electronic device 100 to obtain video stream data after a playback start location of the SP instance video.

S619: The video playback module of the electronic device 100 sends a message 12 to the streaming media service module of the server 200, where the message includes the playback start location information of the SP instance video and the playback address.

S620-S622: The streaming media service module of the server 200 searches for the video stream data after the playback start location of the SP instance video based on the playback start location information of the SP instance video and the playback address. Then, the streaming media service module of the server 200 may send a message 13 to the video playback module of the electronic device 100, where the message includes the video stream data after the playback start location of the SP instance video. Then, the video playback module of the electronic device 100 may play, based on the video stream data after the playback start location of the SP instance video, the SP instance video after the playback start location.

Step S619 to step S622 are similar to step S217 to step S220 shown in FIG. 2D. For a specific execution process, refer to related content of step S217 to step S220 shown in FIG. 2D. Details are not described herein again.

By implementing the method in the embodiment shown in FIG. 2A to FIG. 2D or FIG. 6A to FIG. 6D, during operation of the video, offset information corresponding to a clip inserted into/cropped from the basic video for each SP instance video may be additionally recorded in metadata of the SP instance video. After detecting the operation of switching, by the user, the clip video to the entire video, the electronic device 100 can accurately calculate a continuous playback point of the SP instance video based on parameters such as the offset information. In this case, when one or more clips are inserted into/cropped from the basic video for different SP instance videos, an image played when the user performs the switching operation may still be accurately located in the different SP instance video based on the clip video, and continuous playback is performed, to ensure continuity of video playback before and after switching. This improves user experience. In addition, if some clips that have been inserted/cropped for the SP instance video are adjusted during operation, because offset information corresponding to the inserted/cropped clips is also updated accordingly, the image played when the user performs the switching operation can be accurately located, without a need to re-edit and release the clip video. This reduces operation costs.

Scenario 2: switching an SP instance video (a source SP instance video) to another SP instance video (a destination SP instance video) in an aggregated video:

The following describes a specific execution process of a video processing method in a scenario of switching an SP instance video (a source SP instance video) to another SP instance video (a destination SP instance video) in an aggregated video according to an embodiment of this disclosure.

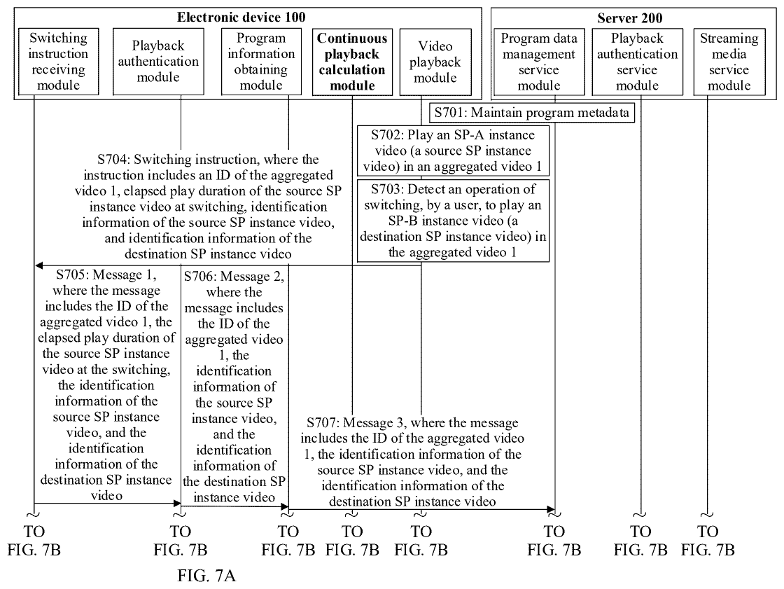

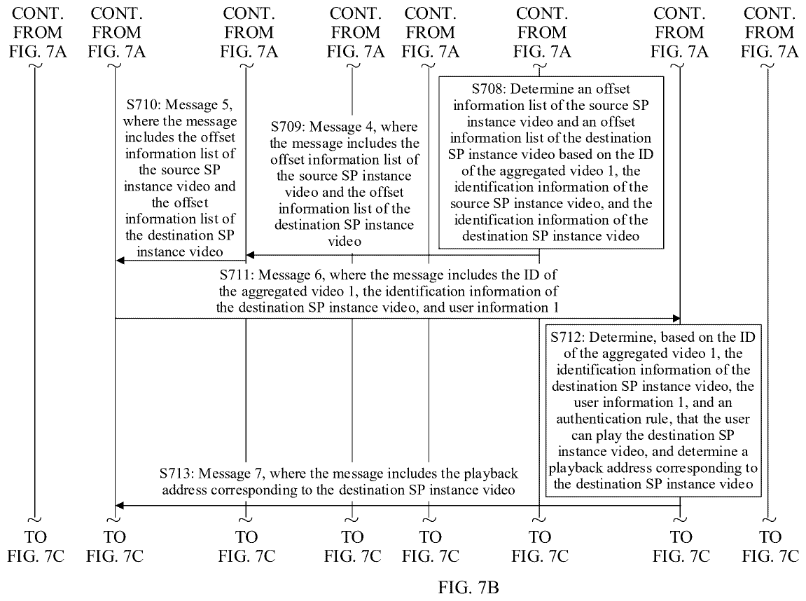

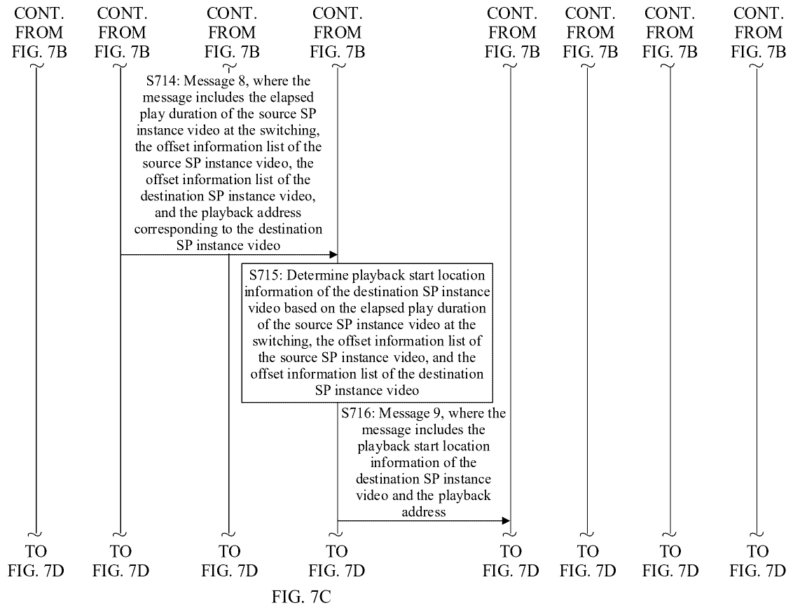

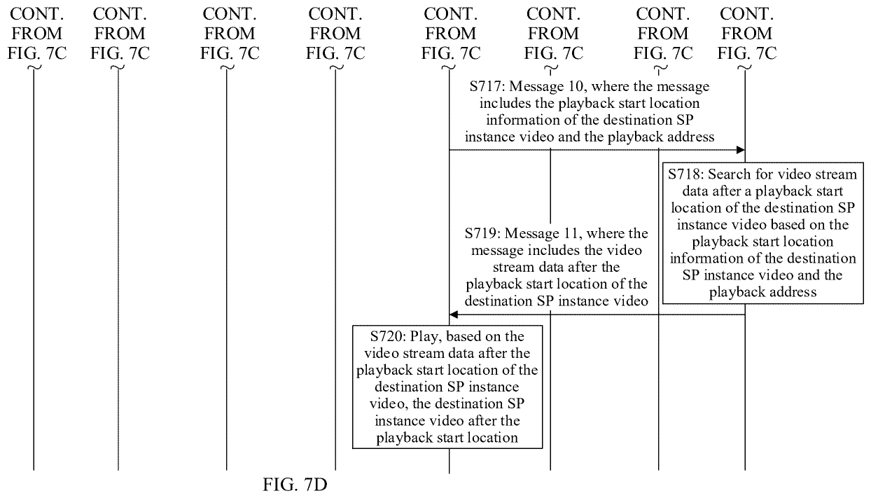

FIG. 7A to FIG. 7D show an example of a specific procedure of a video processing method in a scenario of switching an SP instance video (a source SP instance video) to another SP instance video (a destination SP instance video) in an aggregated video according to an embodiment of this disclosure.

As shown in FIG. 7A to FIG. 7D, the method may be applied to the communication system including the electronic device 100 and the server 200. The electronic device 100 may include a switching instruction receiving module, a playback authentication module, a program information obtaining module, a continuous playback calculation module, and a video playback module. The server 200 may include a program data management service module, a playback authentication service module, and a streaming media service module. The following describes in detail specific steps of the method.

S701: The program data management service module of the server 200 maintains program metadata.

Different from the scenario 1 (switching a clip video to an entire video), in the scenario 2, because only one aggregated video is included and no clip video is included, in a process of maintaining the program metadata, no program information of a clip video needs to be maintained, and only an offset information list of one or more SP instance videos included in the aggregated video needs to be additionally maintained.

To be specific, when operation personnel release, through the program data management service module of the server 200, the one or more SP instance videos included in the aggregated video, the operation personnel need to additionally maintain, in program information of the SP instance video, an offset information list of a corresponding SP instance video.

For descriptions of the offset information list of the SP instance video, refer to related content in step S201 in FIG. 2A. Details are not described herein again.

S702: The video playback module of the electronic device 100 plays an SP-A instance video (a source SP instance video) in the aggregated video 1.

Further, a video playback application (for example, a “Huawei video” application) may be installed on the electronic device 100. The switching instruction receiving module, the playback authentication module, the program information obtaining module, the continuous playback calculation module, and the video playback module that are included in the electronic device 100 may be included in the application. The electronic device 100 may play each SP instance video (for example, an SP-A instance video) in the aggregated video 1 through the video playback module included in the application.

It is easy to understand that, before playing the source SP instance video, the electronic device 100 may obtain a video resource of the source SP instance video from the server 200 in a pre-download or data request manner.

In this embodiment of this disclosure, an example in which the video playback application is a “Huawei video” application is used. This is not limited thereto, and the video playback application may be another application. This is not limited in embodiments of this disclosure.

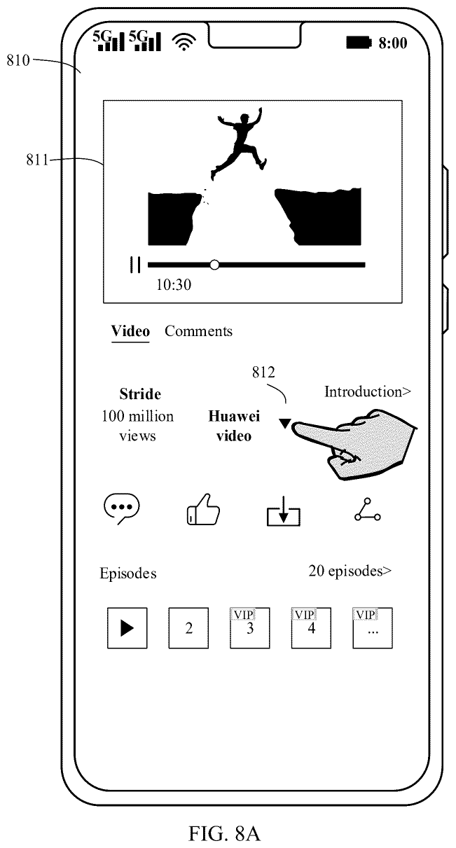

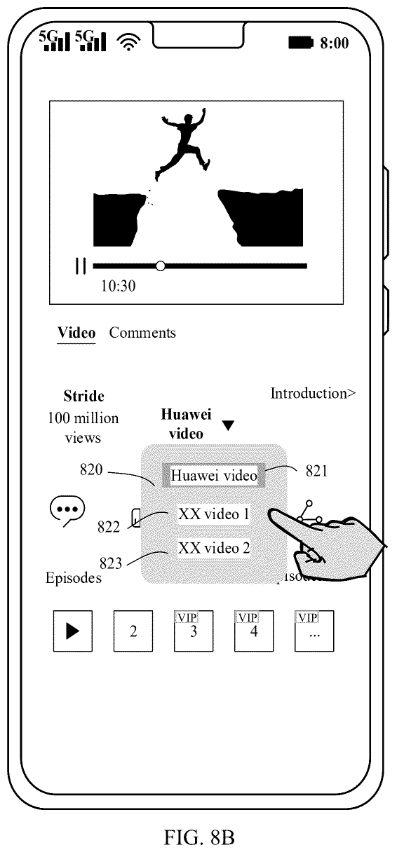

For example, refer to FIG. 8A. FIG. 8A may be a user interface 810 that is used for playing a video and that is provided by the “Huawei video” application. The user interface may include a video playback area 811 and an option 812.

The video playback area 811 may be used to play an SP instance video.

The option 812 may be used by the user to select to play instance videos provided by different SPs.

A video played in the video playback area 811 may be the SP-A instance video in the aggregated video 1. It can be learned that “Huawei video” is used as an example of “SP-A”, in other words, the video played in the video playback area 811 is a playback source provided by an SP “Huawei video”.

The video playback area 811 may further include a video playback progress bar, and the video playback progress bar may display elapsed play duration of a video. It can be seen from the video playback progress bar that elapsed play duration of the SP-A instance video in the aggregated video 1 is 10 minutes and 30 seconds.

S703-S704: The video playback module of the electronic device 100 detects an operation of switching, by the user, to play an SP-B instance video (a destination SP instance video) in the aggregated video 1, and in response to the operation, the video playback module of the electronic device 100 sends a switching instruction to the switching instruction receiving module of the electronic device 100, where the instruction includes an ID of the aggregated video 1, elapsed play duration of the source SP instance video at switching, identification information of the source SP instance video, and identification information of the destination SP instance video.

To avoid different experience (for example, frame freezing) between video streams of different SPs when the user plays the SP-A instance video, the video playback module of the electronic device 100 may provide an option of selecting to play different SP instance videos for the user, so that the user can actively switch between different SP instance videos for playing.

For example, refer to FIG. 8A. The electronic device 100 may detect an operation (for example, a tap operation) performed by the user on the option 812, and in response to the operation, the electronic device 100 may display a window 820 shown in FIG. 8B as an example. The window may include options (for example, an option 821, an option 822, and an option 823) corresponding to a plurality of different SPs (for example, SP-A, SP-B, and SP-C).

For example, SP-A is a “Huawei video”, SP-B is an “XX video 1”, and SP-C is an “XX video 2”. It can be seen from FIG. 8B that a currently played SP instance video in the aggregated video 1 is the SP-A instance video. If the user wants to switch to play the SP-B instance video in the aggregated video 1, the video playback module of the electronic device 100 may detect an operation of switching, by the user, to play the SP-B instance video in the aggregated video 1 (for example, an operation of tapping the option 822), and in response to the operation, the video playback module of the electronic device 100 may send a switching instruction to the switching instruction receiving module of the electronic device 100. The instruction includes the ID of the aggregated video 1, the elapsed play duration of the source SP instance video at the switching, the identification information of the source SP instance video, and the identification information of the destination SP instance video.

It can be learned from FIG. 8B that the elapsed play duration of the source SP instance video at the switching is 10 minutes and 30 seconds, the identification information of the source SP instance video may be identification information of SP-A (for example, a “Huawei video”), and the identification information of the destination SP instance video may be identification information of SP-B (for example, an “XX video 1”).

In this embodiment of this disclosure, the ID of the aggregated video 1, the elapsed play duration of the source SP instance video at the switching, the identification information of the source SP instance video, and the identification information of the destination SP instance video may be included in the switching instruction, or may not be included in the switching instruction, but is separately sent by the video playback module. This is not limited herein.

After receiving the switching instruction sent by the video playback module, the switching instruction receiving module of the electronic device 100 may invoke the playback authentication module of the electronic device 100 to perform playback authentication on the destination SP instance video. Further, the playback authentication module of the electronic device 100 may invoke, based on the switching instruction received by the switching instruction receiving module, the program information obtaining module of the electronic device 100 to query information about the destination SP instance video that needs to be authenticated. Further, the program information obtaining module of the electronic device 100 may invoke, based on the ID of the aggregated video 1, the identification information of the source SP instance video, and the identification information of the destination SP instance video that are included in the switching instruction, the program data management service module of the server 200 to query the information about the destination SP instance video that needs to be authenticated. A possible implementation of the foregoing process may be an implementation described in the following steps S705 to S707.

S705-S707: The switching instruction receiving module of the electronic device 100 sends a message 1 to the playback authentication module of the electronic device 100, where the message may include the ID of the aggregated video 1, the elapsed play duration of the source SP instance video at the switching, the identification information of the source SP instance video, and the identification information of the destination SP instance video. After receiving the message 1, the playback authentication module of the electronic device 100 may send a message 2 to the program information obtaining module of the electronic device 100, where the message may include the ID of the aggregated video 1, the identification information of the source SP instance video, and the identification information of the destination SP instance video. After receiving the message 2, the program information obtaining module of the electronic device 100 may send a message 3 to the program data management service module of the server 200, where the message may include the ID of the aggregated video 1, the identification information of the source SP instance video, and the identification information of the destination SP instance video.

S708: The program data management service module of the server 200 determines an offset information list of the source SP instance video and an offset information list of the destination SP instance video based on the ID of the aggregated video 1, the identification information of the source SP instance video, and the identification information of the destination SP instance video.

Further, after receiving the message 3 sent by the program information obtaining module of the electronic device 100, the program data management service module of the server 200 may find, based on the ID of the aggregated video 1, program information corresponding to all SP instance videos included in the aggregated video. Further, because an offset information list of all SP instance videos included in the aggregated video has been recorded in the process of maintaining the program metadata in step S701, the offset information list of the source SP instance video and the offset information list of the destination SP instance video may be found based on the identification information of the source SP instance video and the identification information of the destination SP instance video.

S709: The program data management service module of the server 200 sends a message 4 to the program information obtaining module of the electronic device 100, where the message includes the offset information list of the source SP instance video and the offset information list of the destination SP instance video.

Further, after performing the foregoing step S708, the program data management service module of the server 200 may send the message 4 to the program information obtaining module of the electronic device 100.

S710: The program information obtaining module of the electronic device 100 sends a message 5 to the playback authentication module of the electronic device 100, where the message includes the offset information list of the source SP instance video and the offset information list of the destination SP instance video.

Further, after receiving the message 4 sent by the program data management service module of the server 200, the program information obtaining module of the electronic device 100 may send the message 5 to the playback authentication module of the electronic device 100.

S711: The playback authentication module of the electronic device 100 sends a message 6 to the playback authentication service module of the server 200, where the message 6 may be used to confirm playback permission of the user. The message 6 may include the ID of the aggregated video 1, the identification information of the destination SP instance video, and user information 1.

Further, after receiving the message 5 sent by the program information obtaining module of the electronic device 100, the playback authentication module of the electronic device 100 may send the message 6 to the playback authentication service module of the server 200.

The user information 1 may be account information used by the user to log in to a video playback application (for example, a “Huawei video” application or an “XX video 1” application). The account information may include but is not limited to a mobile number, an email address, a user-defined user name, and the like.

In some examples, the user information 1 may alternatively be sent in the foregoing step S707. In this case, the playback authentication module of the electronic device 100 does not need to perform the foregoing step S711.

S712: The playback authentication service module of the server 200 determines, based on the ID of the aggregated video 1, the identification information of the destination SP instance video, the user information 1, and an authentication rule, that the user can play the destination SP instance video, and determines a playback address corresponding to the destination SP instance video.

The authentication rule may be preset, and may be used to determine whether the user has permission to play a destination SP instance video.

Further, the playback authentication service module of the server 200 may first find program information of the destination SP instance video based on the ID of the aggregated video 1 and the identification information of the destination SP instance video, and further determine, based on the user information 1 and the authentication rule, whether the user can play (that is, whether the user has permission to play) the destination SP instance video. If the playback authentication service module of the server 200 may first find program information of the destination SP instance video and determine that the user can play the destination SP instance video, the playback authentication service module of the server 200 may obtain the playback address corresponding to the destination SP instance video from the found program information of the destination SP instance video.

For example, it is assumed that the authentication rule specifies that, for the destination SP instance video, only a user who subscribes to a membership of the SP has permission to play the destination SP instance video. If it is determined based on the user information 1 that the user is a member user of the SP, it may be further determined that the user can play the SP instance video, or if it is determined that the user is a non-member user of the SP, it may be further determined that the user cannot play the SP instance video, and subsequent steps are not performed.

S713: The playback authentication service module of the server 200 sends a message 7 to the playback authentication module of the electronic device 100, where the message includes the playback address corresponding to the destination SP instance video.

Further, after performing the foregoing step S712, the playback authentication service module of the server 200 may send the message 7 to the playback authentication module of the electronic device 100.

S714: The playback authentication module of the electronic device 100 sends a message 8 to the continuous playback calculation module of the electronic device 100, where the message includes the elapsed play duration of the source SP instance video at the switching, the offset information list of the source SP instance video, the offset information list of the destination SP instance video, and the playback address corresponding to the destination SP instance video.

Further, after receiving the message 7 sent by the playback authentication service module of the server 200, the playback authentication module of the electronic device 100 may send the message 8 to the continuous playback calculation module of the electronic device 100. The message 8 indicates the continuous playback calculation module to calculate playback start location information of the destination SP instance video.

S715: The continuous playback calculation module of the electronic device 100 determines the playback start location information of the destination SP instance video based on the elapsed play duration of the source SP instance video at the switching, the offset information list of the source SP instance video, and the offset information list of the destination SP instance video.

Further, after receiving the message 8 sent by the playback authentication module of the electronic device 100, the continuous playback calculation module of the electronic device 100 may determine the playback start location information of the destination SP instance video based on the elapsed play duration of the source SP instance video at the switching, the offset information list of the source SP instance video, and the offset information list of the destination SP instance video that are included in the message.

The following describes in detail a specific process that “the continuous playback calculation module of the electronic device 100 determines the playback start location information of the destination SP instance video based on the elapsed play duration of the source SP instance video at the switching, the offset information list of the source SP instance video, and the offset information list of the destination SP instance video”.

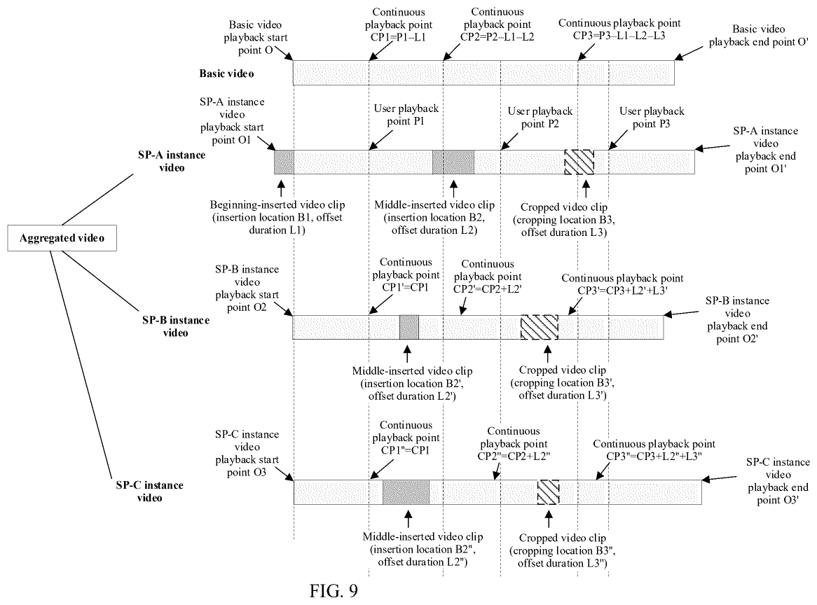

For example, refer to FIG. 9. FIG. 9 is a principle diagram of performing continuous playback calculation in a scenario of “switching an SP instance video (a source SP instance video) to another SP instance video (a destination SP instance video) in an aggregated video” according to an embodiment of this disclosure.

As shown in FIG. 9, it is assumed that the aggregated video includes an SP-A instance video, an SP-B instance video, and an SP-C instance video. The SP-A instance video, the SP-B instance video, and the SP-C instance video are obtained by inserting some clips into/cropping some clips from the basic video shown in FIG. 9 by different SPs due to an operation reason. Duration of the basic video is a time difference between a playback end point O′ of the basic video and a playback start point O of the basic video.

The “elapsed play duration of the source SP instance video at switching” may be determined based on a user playback point Pi (a time point of a playback progress of the source SP instance video in a case in which the user performs a switching action), where i is a positive integer. For example, if the user playback point Pi is 10:30, the elapsed play duration of the source SP instance video at the switching is 10 minutes and 30 seconds.

The “offset information list of the source SP instance video” may be determined based on a start location of the clip inserted into/cropped from the basic video and offset duration. The offset information list of the source SP instance video is recorded in the process of maintaining the program metadata. For example, the source SP instance video is an SP-A instance video. It can be seen that the SP-A instance video is obtained by inserting two clips (a beginning-inserted video clip and a middle-inserted video clip) into the basic video and cropping a clip (a cropped video clip) from the basic video. An insertion location of the beginning-inserted video clip is B1 and offset duration is L1. An insertion location of the middle-inserted video clip is B2 and offset duration is L2. A cropping location of the cropped video clip is B3 and offset duration is L3. Therefore, an offset information list of the SP-A instance video may be represented as {δ1 (B1, L1), δ1 (B2, L2), δ1 (B3, L3)}.

The “offset information list of the destination SP instance video” may be determined based on the start location of the clip inserted into/cropped from the basic video and the offset duration. The offset information list of the destination SP instance video is recorded in the process of maintaining the program metadata. For example, the destination SP instance video is an SP-B instance video. It can be seen that the SP-B instance video is obtained by inserting a clip (a middle-inserted video clip) into the basic video and cropping a clip (a cropped video clip) from the basic video. An insertion location of the middle-inserted video clip is B2′ and offset duration is L2′. A cropping location of the cropped video clip is B3′ and offset duration is L3′. Therefore, an offset information list of the SP-B instance video may be represented as {δ2(B2′, L2′), δ2(B3′, L3′)}.

The continuous playback calculation module may first determine the user playback point Pi in the source SP instance video based on the elapsed play duration of the source SP instance video at the switching, determine whether a clip is inserted into/cropped from the source SP instance video before a location of the user playback point Pi, and then determine a continuous playback point of the basic video based on the user playback point Pi and the offset information list of the source SP instance video.

In some examples, the “elapsed play duration of the source SP instance video at switching” in the foregoing steps may be replaced with the “user playback point Pi”. In this way, the continuous playback calculation module does not need to determine the user playback point Pi based on the elapsed play duration of the source SP instance video at the switching.

“Whether a clip is inserted/cropped before a location of the user playback point Pi in the source SP instance video” may be comprehensively determined based on the user playback point Pi, an insertion location/a cropping location of a clip inserted/cropped for the source SP instance video, and offset duration. For example, it is assumed that offset information of an inserted clip 1 is δ(00:00, 10 s), offset information of an inserted clip 2 is δ(10:00, 20 s), offset information of a cropped clip 1 is δ(20:00, −10 s) in the source SP instance video. If the user playback point Pi is 6:00, elapsed play duration of the source SP instance video is 6 minutes. Because offset duration of the inserted clip 1 is 10 s and is less than 6 minutes, and both an insertion location 10:00 of the inserted clip 2 and a cropping location 20:00 of the cropped clip 1 are after 6:00, only one clip is inserted before the location of the user playback point Pi: the inserted clip 1. If the user playback point Pi is 15:00, elapsed play duration of the source SP instance video is 15 minutes. Because a location obtained by adding up offset duration of the inserted clip 1 and an insertion location 10:00 of the inserted clip 2 is 10:10 and is still before 15:00, and a cropping location 20:00 of the cropped clip 1 is after 15:00, two clips are inserted before the location of the user playback point Pi: the inserted clip 1 and the inserted clip 2. If the user playback point Pi is 25:00, elapsed play duration of the source SP instance video is 25 minutes. Because a location obtained by adding up offset duration of the inserted clip 1, offset duration of the inserted clip 2, and a cropping location 20:00 of cropped clip 2 is 20:30 and is still before 25:00, and a cropping location 20:00 of the cropped clip 1 is before 25:00, two clips are inserted before the location of the user playback point Pi: the inserted clip 1 and the inserted clip 2, and a clip is cropped: the cropped clip 1.

A process of “determining a continuous playback point of the basic video based on the user playback point Pi and the offset information list of the source SP instance video” is as follows: It is assumed that a user playback point is P. In this case, a continuous playback point CP of the basic video is CP=P−Σᵢ₌₁ⁿLᵢ, where n is a total quantity of clips inserted into and cropped from the source SP instance video before a location of the user playback point P, and Lᵢ is offset duration of an i^{th} clip inserted into/cropped from the source SP instance video before the location of the user playback point P.

Specially, when the user playback point P is in a beginning-inserted clip (that is, the user performs a switching operation in a process of playing the beginning-inserted clip), the calculated CP is less than 0. In this case, 0 may be assigned to CP. When the user playback point P is in a middle-inserted clip (that is, the user performs a switching operation in a process of playing the middle-inserted clip), it is easy to understand that the middle-inserted clip is the last clip inserted into the source SP instance video before the location of the user playback point P, namely, an n^{th} clip. In this case, Ln is not offset duration of the middle-inserted clip but elapsed play duration of the middle-inserted clip at the user playback point P.

For example, refer to FIG. 9. The source SP instance video is an SP-A instance video, and a continuous playback point, corresponding to a user playback point P1, of the basic video is CP1. It can be seen that a clip (a beginning-inserted video clip) is inserted into the source SP instance video before a location of P1. In this case, a continuous playback point of the basic video is CP1=P1−L1. A continuous playback point, corresponding to a user playback point P2, of the basic video is CP2. It can be seen that two clips (a beginning-inserted video clip and a middle-inserted video clip) are inserted into the source SP instance video before a location of P2. In this case, the continuous playback point of the basic video is CP2=P2−L1−L2. A continuous playback point, corresponding to a user playback point P3, of the basic video is CP3. It can be seen that two clips (a beginning-inserted video clip and a middle-inserted video clip) are inserted into the source SP instance video before a location of P3 and one clip (a cropped video clip) is cropped. In this case, the continuous playback point of the basic video is CP3=P3−L1−L2−L3. It is easy to understand that offset duration of the inserted clip is a positive number, and offset duration of the cropped clip is a negative number.

After the continuous playback point of the basic video is determined, it needs to be determined whether a clip is inserted into/cropped from the destination SP instance video before a location of the continuous playback point of the basic video. If a clip is inserted/cropped, a continuous playback point of the destination SP instance video is a point obtained by adding up the continuous playback point of the basic video and offset duration of all clips inserted/cropped before the location of the continuous playback point of the basic video. If no clip is inserted/cropped, a continuous playback point of the destination SP instance video is the continuous playback point of the basic video.

To be specific, it is assumed that the continuous playback point of the basic video is CP. In this case, a continuous playback point CP' of the destination SP instance video is CP′=CP+Σᵢ₌₁ⁿLᵢ, where n is a total quantity of clips inserted into and cropped from the destination SP instance video before the location of the continuous playback point of the basic video, and Lᵢ is offset duration of an i^{th} clip inserted into/cropped from the destination SP instance video before the location of the continuous playback point of the basic video.

For example, refer to FIG. 9. The destination SP instance video is an SP-B instance video, and a continuous playback point, corresponding to a user playback point P1, of the basic video is CP1. It can be seen that no clip is inserted into/cropped from the destination SP instance video before a location of CP1. In this case, a continuous playback point of the destination SP instance video is CP1′=CP1. A continuous playback point, corresponding to a user playback point P2, of the basic video is CP2. It can be seen that a clip (a middle-inserted video clip) is inserted into the destination SP instance video before a location of CP2. In this case, a continuous playback point of the destination SP instance video is CP2′=CP2+L2′. A continuous playback point, corresponding to a user playback point P3, of the basic video is CP3. It can be seen that a clip (a middle-inserted video clip) is inserted into the destination SP instance video before a location of CP3 and a clip (a cropped video clip) is cropped. In this case, a continuous playback point of the destination SP instance video is CP3′=CP3+L2′+L3′. It is easy to understand that offset duration of the inserted clip is a positive number, and offset duration of the cropped clip is a negative number.

A process of “determining whether a clip is inserted into/cropped from the destination SP instance video before a location of the continuous playback point of the basic video” is as follows: If an insertion location or a cropping location, of the clip inserted into/cropped from the basic video, recorded in the offset information list of the destination SP instance video is before the location of the continuous playback point of the basic video, it is determined that a clip is inserted/cropped for the destination SP instance video before the location of the continuous playback point of the basic video.

It is easy to understand that, that the clip is inserted/cropped for the destination SP instance video before the location of the continuous playback point of the basic video means that the clip is inserted/cropped before the location of the continuous playback point of the destination SP instance video, and that no clip is inserted/cropped for the destination SP instance video before the location of the continuous playback point of the basic video means that no clip is inserted/cropped before the location of the continuous playback point of the destination SP instance video.

Refer to FIG. 9. An offset information list of the SP-C instance video may be represented as {δ(B2″, L2″), δ(B3″, L3″)}. Duration of the SP-C instance video is a time difference between a playback end point O3′ of the SP-C instance video and a playback start point O3 of the SP-C instance video. Similarly, a continuous playback point of the SP-C instance video may also be calculated according to the foregoing manner of calculating the continuous playback point of the SP-B instance video. It is easy to understand that, when a user playback point is P1, a continuous playback point of the SP-C instance video is CP1″=CP1, when a user playback point is P2, a continuous playback point of the SP-C instance video is CP2″=CP2+L2″, or when a user playback point is P3, a continuous playback point of the SP-C instance video is CP3″=CP3+L2″+L3″.

In conclusion, it is assumed that the user playback point is P (a time point of a playback progress of the source SP instance video in a case in which the user performs a switching action), the continuous playback point of the basic video is CP, and the continuous playback point of the destination SP instance video is CP′. In this case, CP′=CP+Σᵢ₌₁ⁿLᵢ=P−Σ_{b=1}^{a}L_{b}+Σᵢ₌₁ⁿLᵢ, where a is the total quantity of clips inserted into and cropped from the source SP instance video before the location of the user playback point P, L_{b} is offset duration of a b^{th} clip inserted into/cropped from the source SP instance video before the location of the user playback point P, n is a total quantity of clips inserted into and cropped from the destination SP instance video before a location of the continuous playback point CP of the basic video, and Lᵢ is offset duration of an i^{th} clip inserted into/cropped from the destination SP instance video before the location of the continuous playback point CP of the basic video.

S716: The continuous playback calculation module of the electronic device 100 sends a message 9 to the video playback module of the electronic device 100, where the message includes the playback start location information of the destination SP instance video and the playback address.

Further, after performing the foregoing step S715, the continuous playback calculation module of the electronic device 100 may send the message 9 to the video playback module of the electronic device 100. The message 9 indicates the video playback module of the electronic device 100 to obtain video stream data after a playback start location of the destination SP instance video.

S717: The video playback module of the electronic device 100 sends a message 10 to the streaming media service module of the server 200, where the message includes the playback start location information of the destination SP instance video and the playback address.

Further, after receiving the message 9 sent by the continuous playback calculation module of the electronic device 100, the video playback module of the electronic device 100 may send the message 10 to the streaming media service module of the server 200, so as to obtain the video stream data after the playback start location of the destination SP instance video from the streaming media service module of the server 200.

S718-S720: The streaming media service module of the server 200 searches for the video stream data after the playback start location of the destination SP instance video based on the playback start location information of the destination SP instance video and the playback address. Then, the streaming media service module of the server 200 may send a message 11 to the video playback module of the electronic device 100, where the message includes the video stream data after the playback start location of the destination SP instance video. Then, the video playback module of the electronic device 100 may play, based on the video stream data after the playback start location of the destination SP instance video, the destination SP instance video after the playback start location.

For example, it is assumed that the elapsed play duration of the source SP instance video at the switching is 10 minutes and 30 seconds. In this case, the user playback point P (the time point of the playback progress of the source SP instance video in the case in which the user performs the switching action) is 10:30, and the continuous playback point CP′ (the playback start location information of the destination SP instance video) of the destination SP instance video is CP′=P−Σ_{b=1}^{a}L_{b}+Σᵢ₌₁ⁿLᵢ=P−(Σ_{b=1}^{a}L_{b}−Σᵢ₌₁ⁿLᵢ), where a is a total quantity of clips inserted into/cropped from the source SP instance video before the location of the user playback point P, L_{b} is the offset duration of the b^{th} clip inserted into/cropped from the source SP instance video before the location of the user playback point P, n is a total quantity of clips inserted into/cropped from the destination SP instance video before the location of the continuous playback point CP of the basic video, Lᵢ is the offset duration of the i^{th} clip inserted into/cropped from the destination SP instance video before the location of the continuous playback point CP of the basic video.

1. In a case in which Σ_{b=1}^{a}L_{b}−Σᵢ₌₁ⁿLᵢ is 0, the continuous playback point CP′ of the destination SP instance video is the same as the user playback point P, that is, both are 10:30.

For example, the destination SP instance video may be an instance video provided by an SP “XX video 1”. The playback start location (the continuous playback point of the destination SP instance video) of the destination SP instance video is 10:30, that is, a location, of an image played in the source SP instance video when the user performs a switching operation, in the destination SP instance video is 10:30. Further, the electronic device 100 may continue to play, at 10:30 based on the obtained video stream data after the playback start location of the destination SP instance video, the destination SP instance video after the playback start location.

2. In a case in which Σ_{b=1}^{a}L_{b}−ΣEᵢ₌₁ⁿLᵢ is not 0, the continuous playback point CP′ of the destination SP instance video is different from the user playback point P.

It is assumed that Σ_{b=1}^{a}L_{b}−Σᵢ₌₁ⁿLᵢ is 20 seconds in a case in which Σ_{b=1}^{a}L_{b}−Σᵢ₌₁ⁿLᵢ is greater than 0. In this case, the continuous playback point CP′ of the destination SP instance video is CP′=10:30−20=10:10.

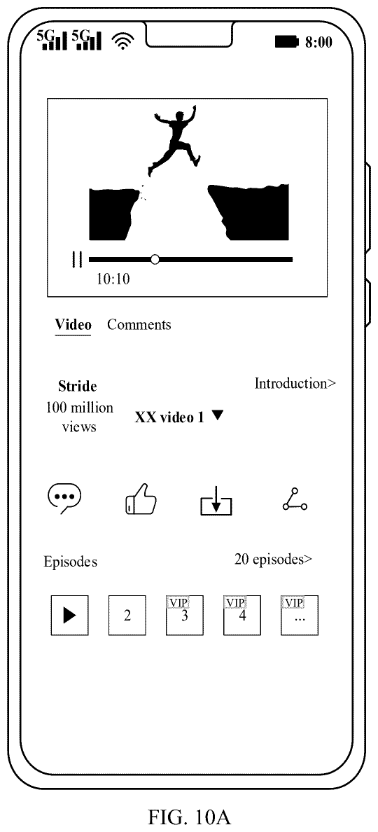

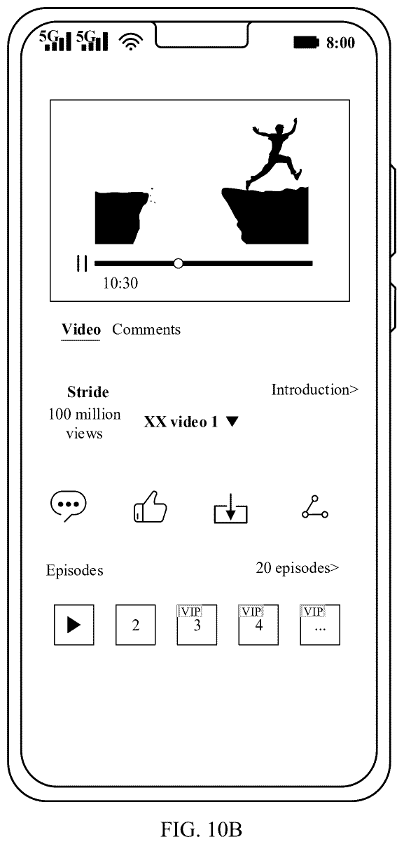

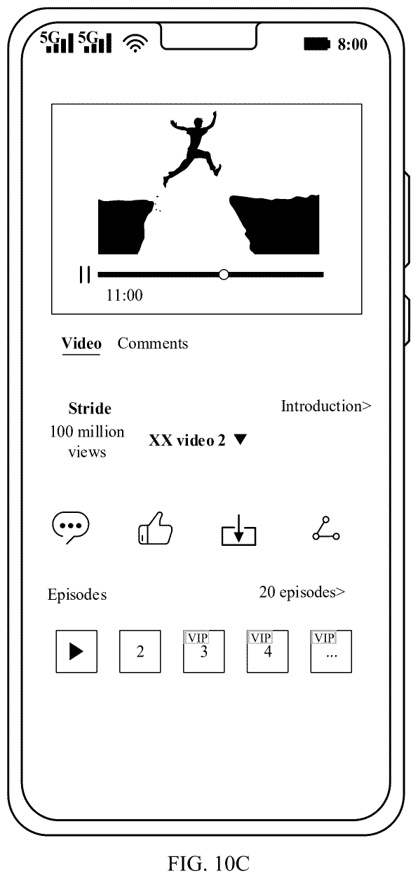

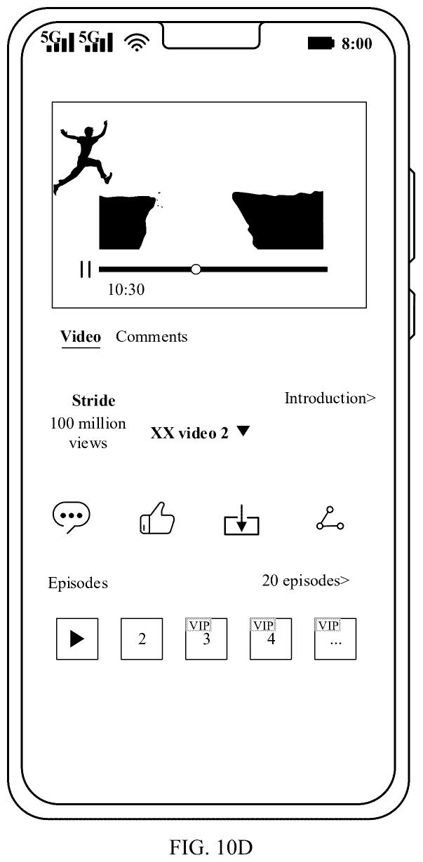

For example, refer to FIG. 10A. A user interface shown in FIG. 10A may be a user interface displayed when the user continues to play a destination SP instance video after performing a switching operation. For example, the destination SP instance video may be an instance video provided by the SP “XX video 1”. It can be learned that a playback start location of the destination SP instance video (a continuous playback point of the destination SP instance video) is 10:10, in other words, a location, of an image played in the source SP instance video when the user performs the switching operation, in the destination SP instance video is 10:10. Further, the electronic device 100 may continue to play, at 10:10 based on the obtained video stream data after the playback start location of the destination SP instance video, the destination SP instance video after the playback start location.

It is easy to understand that, in the case in which Σ_{b=1}^{a}L_{b}−Σᵢ₌₁ⁿLᵢ is greater than 0, if impact of offset duration of the inserted/cropped clip on calculation of the continuous playback point is not considered during calculation of the continuous playback point of the destination SP instance video, the calculated continuous playback point of the destination SP instance video is the same as the user playback point and is still 10:30. In this case, a continuous playback start image is an image corresponding to 10:30 in the destination SP instance video (for example, an image shown in FIG. 10B), and is inconsistent with an image played in the source SP instance video (for example, an image corresponding to 10:10 in the destination SP instance video shown in FIG. 10A). This cannot implement continuity of video playback before and after switching, resulting in poor user experience.

The foregoing describes the case in which Σ_{b=1}^{a}L_{b}−Σᵢ₌₁ⁿLᵢ is greater than 0 by using an example in which the destination SP instance video is an instance video provided by the SP “XX video 1”. The following describes a case in which Σ_{b=1}^{a}L_{b}−Σᵢ₌₁ⁿLᵢ is less than 0 by using an example in which the destination SP instance video is an instance video provided by an SP “XX video 2”.

It is easy to understand that, when the destination SP instance video is an instance video provided by the SP “XX video 2”, the foregoing step S703 may include that the video playback module of the electronic device 100 detects an operation of switching, by the user, to play the SP-C instance video in the aggregated video 1 (for example, an operation of tapping the option 823 shown in FIG. 8B).

It is assumed that Σ_{b=1}^{a}L_{b}−Σᵢ₌₁ⁿLᵢ is −30 seconds. In this case, the continuous playback point CP′ of the destination SP instance video is CP′=10:30+30=11:00.

For example, refer to FIG. 10C. A user interface shown in FIG. 10C may be a user interface displayed when the user continues to play a destination SP instance video after performing a switching operation. For example, the destination SP instance video may be an instance video provided by the SP “XX video 2”. It can be learned that a playback start location of the destination SP instance video (a continuous playback point of the destination SP instance video) is 11:00, in other words, a location, of an image played in the source SP instance video when the user performs the switching operation, in the destination SP instance video is 11:00. Further, the electronic device 100 may continue to play, at 10:50 based on the obtained video stream data after the playback start location of the destination SP instance video, the destination SP instance video after the playback start location.

It is easy to understand that, in the case in which Σ_{b=1}^{a}L_{b}−Σᵢ₌₁ⁿLᵢ is less than 0, if impact of offset duration of the inserted/cropped clip on calculation of the continuous playback point is not considered during calculation of the continuous playback point of the destination SP instance video, the calculated continuous playback point of the destination SP instance video is the same as the user playback point and is still 10:30. In this case, a continuous playback start image is an image corresponding to 10:30 in the destination SP instance video (for example, an image shown in FIG. 10D). Therefore, the user needs to continue to play the video for 30 seconds to display an image played in the source SP instance video when the user performs the switching operation (for example, an image corresponding to 11:00 in the destination SP instance video shown in FIG. 10C). It is easy to understand that this 30-second video is played before the user performed the switching operation. This cannot implement continuity of video playback before and after switching, resulting in poor user experience.

Scenario 2: switching an SP instance video (a source SP instance video) to another SP instance video (a destination SP instance video) in an aggregated video:

The following describes a specific execution process of a video processing method in a scenario of switching an SP instance video (a source SP instance video) to another SP instance video (a destination SP instance video) in an aggregated video according to an embodiment of this disclosure.

FIG. 11A to FIG. 11D show an example of a specific procedure of another video processing method in a scenario of switching an SP instance video (a source SP instance video) to another SP instance video (a destination SP instance video) in an aggregated video according to an embodiment of this disclosure.

As shown in FIG. 11A to FIG. 11D, the method may be applied to the communication system including the electronic device 100 and the server 200. The electronic device 100 may include a switching instruction receiving module, a playback authentication module, a program information obtaining module, and a video playback module. The server 200 may include a program data management service module, a playback authentication service module, a continuous playback calculation module, and a streaming media service module. Different from the continuous playback calculation module in FIG. 7A, the continuous playback calculation module in FIG. 11A is included in the server 200 instead of the electronic device 100. The following describes in detail specific steps of the method.

S1101: The program data management service module of the server 200 maintains program metadata.

S1102: The video playback module of the electronic device 100 plays an SP-A instance video (a source SP instance video) in the aggregated video 1.

S1103-S1104: The video playback module of the electronic device 100 detects an operation of switching, by the user, to play an SP-B instance video (a destination SP instance video) in the aggregated video 1, and in response to the operation, the video playback module of the electronic device 100 sends a switching instruction to the switching instruction receiving module of the electronic device 100, where the instruction includes an ID of the aggregated video 1, elapsed play duration of the source SP instance video at switching, identification information of the source SP instance video, and identification information of the destination SP instance video.

S1105: The switching instruction receiving module of the electronic device 100 sends a message 1 to the playback authentication module of the electronic device 100, where the message may include the ID of the aggregated video 1, the elapsed play duration of the source SP instance video at the switching, the identification information of the source SP instance video, and the identification information of the destination SP instance video.

Step S1101 to step S1105 are similar to step S701 to step S705 shown in FIG. 7A. For a specific execution process, refer to related content of step S701 to step S705 shown in FIG. 7A. Details are not described herein again.

S1106: The playback authentication module of the electronic device 100 sends a message 2 to the playback authentication service module of the server 200, where the message may include the ID of the aggregated video 1, the elapsed play duration of the source SP instance video at the switching, the identification information of the source SP instance video, the identification information of the destination SP instance video, and user information 1.

The user information 1 is the same as the user information 1 in step S711 in FIG. 7B. Details are not described herein again.

The message 2 may be directly sent by the playback authentication module of the electronic device 100 to the playback authentication service module of the server 200, or may be sent by the playback authentication module of the electronic device 100 to the playback authentication service module of the server 200 through the program information obtaining module of the electronic device 100. This is not limited in embodiments of this disclosure.

S1107: The playback authentication service module of the server 200 determines, based on the ID of the aggregated video 1, the identification information of the destination SP instance video, the user information 1, and an authentication rule, that the user can play the destination SP instance video, and determines a playback address corresponding to the destination SP instance video.

Step S1107 is similar to step S712 shown in FIG. 7B. For a specific execution process, refer to related content of step S712 shown in FIG. 7B. Details are not described herein again.

S1108: The playback authentication service module of the server 200 sends a message 3 to the program data management service module of the server 200, where the message includes the ID of the aggregated video 1, the identification information of the source SP instance video, and the identification information of the destination SP instance video.

S1109: The program data management service module of the server 200 determines an offset information list of the source SP instance video and an offset information list of the destination SP instance video based on the ID of the aggregated video 1, the identification information of the source SP instance video, and the identification information of the destination SP instance video.

Step S1109 is similar to step S708 shown in FIG. 7B. For a specific execution process, refer to related content of step S708 shown in FIG. 7B. Details are not described herein again.

S1110: The program data management service module of the server 200 sends a message 4 to the playback authentication service module of the server 200, where the message includes the offset information list of the source SP instance video and the offset information list of the destination SP instance video.

Further, after performing the foregoing step S1109, the program data management service module of the server 200 may send the message 4 to the playback authentication service module of the server 200.

S1111: The playback authentication service module of the server 200 sends a message 5 to the continuous playback calculation module of the server 200, where the message includes the elapsed play duration of the source SP instance video at the switching, the offset information list of the source SP instance video, and the offset information list of the destination SP instance video.

Further, after receiving the message 4 sent by the program data management service module of the server 200, the playback authentication service module of the server 200 may send the message 5 to the continuous playback calculation module of the server 200.

S1112: The continuous playback calculation module of the server 200 determines playback start location information of the destination SP instance video based on the elapsed play duration of the source SP instance video at the switching, the offset information list of the source SP instance video, and the offset information list of the destination SP instance video.

Step S1112 is similar to step S715 shown in FIG. 7C. For a specific execution process, refer to related content of step S715 shown in FIG. 7C. Details are not described herein again.

S1113: The continuous playback calculation module of the server 200 sends a message 6 to the playback authentication service module of the server 200, where the message includes the playback start location information of the destination SP instance video.

Further, after performing the foregoing step S1102, the continuous playback calculation module of the server 200 may send the message 6 to the playback authentication service module of the server 200.

S1114: The playback authentication service module of the server 200 sends a message 7 to the playback authentication module of the electronic device 100, where the message includes the playback start location information of the destination SP instance video and the playback address.

Further, after receiving the message 6 sent by the continuous playback calculation module of the server 200, the playback authentication service module of the server 200 may send the message 7 to the playback authentication module of the electronic device 100.

S1115: The playback authentication module of the electronic device 100 sends a message 8 to the video playback module of the electronic device 100, where the message includes the playback start location information of the destination SP instance video and the playback address.

Further, after receiving the message 7 sent by the playback authentication service module of the server 200, the playback authentication module of the electronic device 100 may send the message 8 to the video playback module of the electronic device 100. The message 8 indicates the video playback module of the electronic device 100 to obtain video stream data after a playback start location of the destination SP instance video.

S1116: The video playback module of the electronic device 100 sends a message 9 to the streaming media service module of the server 200, where the message includes the playback start location information of the destination SP instance video and the playback address.

S1117-S1119: The streaming media service module of the server 200 searches for the video stream data after the playback start location of the destination SP instance video based on the playback start location information of the destination SP instance video and the playback address. Then, the streaming media service module of the server 200 may send a message 10 to the video playback module of the electronic device 100, where the message includes the video stream data after the playback start location of the destination SP instance video. Then, the video playback module of the electronic device 100 may play, based on the video stream data after the playback start location of the destination SP instance video, the destination SP instance video after the playback start location.

Step S1116 to step S1119 are similar to step S717 to step S720 shown in FIG. 7D. For a specific execution process, refer to related content of step S717 to step S720 shown in FIG. 7D. Details are not described herein again.

By implementing the method in the embodiment shown in FIG. 7A to FIG. 7D or FIG. 11A to FIG. 11D, during operation of the aggregated video, offset information corresponding to a clip inserted into/cropped from the basic video for each SP instance video may be additionally recorded in metadata of the SP instance video. After detecting an operation of switching, by the user, a source SP instance video to a destination SP instance video in the aggregated video, the electronic device 100 can accurately calculate a continuous playback point of the destination SP instance video based on the recorded parameters such as the offset information of the source SP instance video and the offset information of the destination SP instance video. In this case, when one or more different clips are inserted into/cropped from the basic video for the source SP instance video and the destination SP instance video, an image played in the source SP instance video when the user performs the switching operation can still be accurately located in the destination SP instance video, and continuous playback is performed, to ensure continuity of video playback before and after switching. This improves user experience.

It can be easily learned from a principle diagram of continuous playback calculation shown in FIG. 4 or FIG. 9 that, it is assumed that the electronic device plays a video (for example, a clip video/a source SP instance video), at a playback point 1 (for example, a first time point) of the video, the electronic device 100 displays a user interface (for example, a second user interface), where the user interface includes an image (an image 1, for example, a first image) of the video, and at a playback point 2 (which may be a third time point) of the video, the electronic device 100 displays another user interface (which may be a third user interface), where the user interface includes another image (an image 2 that may be a second image) of the video. A time interval between the playback point 1 and the playback point 2 is an interval 1 (which may be a first interval). A playback progress corresponding to the image 1 in the basic video is CP1 (which may be a fifth time point). A playback progress corresponding to the image 2 in the basic video is CP2 (which may be a fourth time point). A time interval between the CP1 and the CP2 is an interval 2 (which may be a second interval). One or more clips are inserted and/or cropped during a time period between the playback point 1 and the playback point 2 of the video. In this case, when a sum of offset duration of the one or more clips is not 0, the interval 1 and the interval 2 are different.

In embodiments of this disclosure, the electronic device may be the electronic device 100, and the server may be the server 200. The first video may be a clip video or a source SP instance video. The first user interface may be a user interface for playing a clip video (for example, a user interface shown in FIG. 3B, FIG. 3C, FIG. 3D, or FIG. 3E) or a user interface for playing a source SP instance video (for example, a user interface shown in FIG. 8B). The first image may be an image of a clip video (for example, an image of a played clip video shown in FIG. 3B, FIG. 3C, FIG. 3D, or FIG. 3E) or an image of a source SP instance video (for example, an image of a played source SP instance video shown in FIG. 8B). The first operation may be an operation of switching, by the user, to play an entire video associated with a clip video (for example, an operation of tapping, by the user, an option “View full version”/“View full video” shown in FIG. 3B, FIG. 3C, FIG. 3D, or FIG. 3E) or an operation of switching, by the user, to play a destination SP instance video (for example, an operation of tapping, by the user, an option “XX video 1” shown in FIG. 8B). The second video may be an entire SP instance video or a destination SP instance video associated with a clip video. The second user interface may be a user interface of an entire SP instance video associated with a clip video (for example, a user interface shown in FIG. 5A, FIG. 5B, or FIG. 5D) or a user interface for playing a destination SP instance video (for example, the user interface shown in FIG. 10A or FIG. 10C). The third video may be a basic video. The first time point may be a continuous playback point of the second video. The one or more first clips may be one or more clips that are inserted into and/or cropped from the third video before the first time point to obtain the second video. The first video source may be a video source of a source SP instance video (for example, a Huawei video). The second video source may be a video source of a destination SP instance video (for example, an XX video 1 or an XX video 2). The second time point may be a playback progress (a user playback point) corresponding to the first video when the user performs the first operation. The first user information may be the user information 1. The elapsed play duration of the first video may be elapsed play duration of the first video at switching. The first message may be the message 3 in FIG. 2A or FIG. 6A. The identifier of the first video may be an ID of a clip video. The second message may be the message 4 in FIG. 2B. The third message may be the message 6 in FIG. 6B. The fourth message may be the message 10 in FIG. 6C. The fifth message may be the message 10 in FIG. 2D or the message 12 in FIG. 6D. The fifth time point may be a continuous playback point of the basic video. The one or more second clips may be one or more clips that are inserted into and/or cropped from the basic video to obtain the second video. The sixth message may be the message 3 in FIG. 7A. The seventh message may be the message 4 in FIG. 7B. The eighth message may be the message 2 in FIG. 11A. The elapsed play duration of the first video may be elapsed play duration of the source SP instance video at switching. The ninth message may be a message 7 in FIG. 11C.

The following describes an internal module of an electronic device 100, an internal module of a server 200, and a possible manner of collaboration between internal modules that are included in a process of performing a video processing method according to an embodiment of this disclosure.

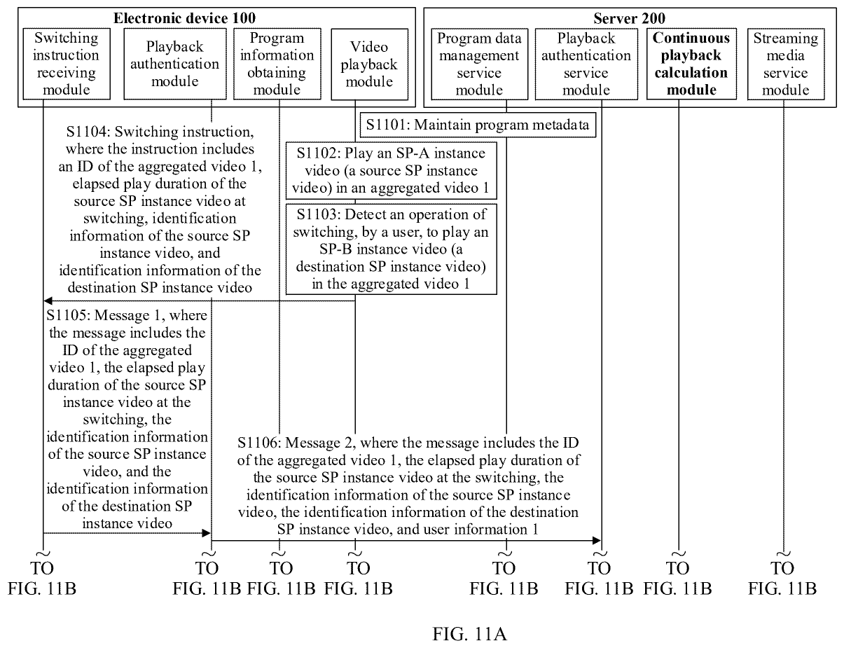

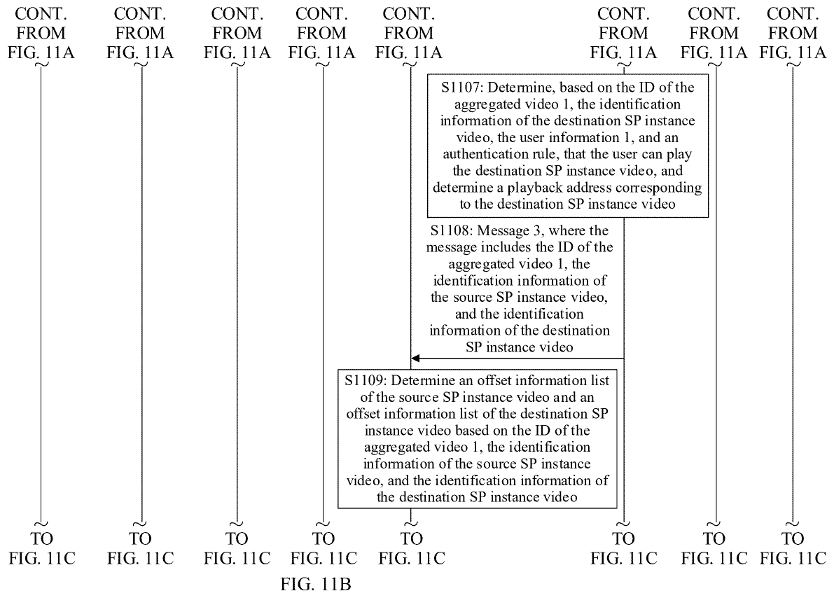

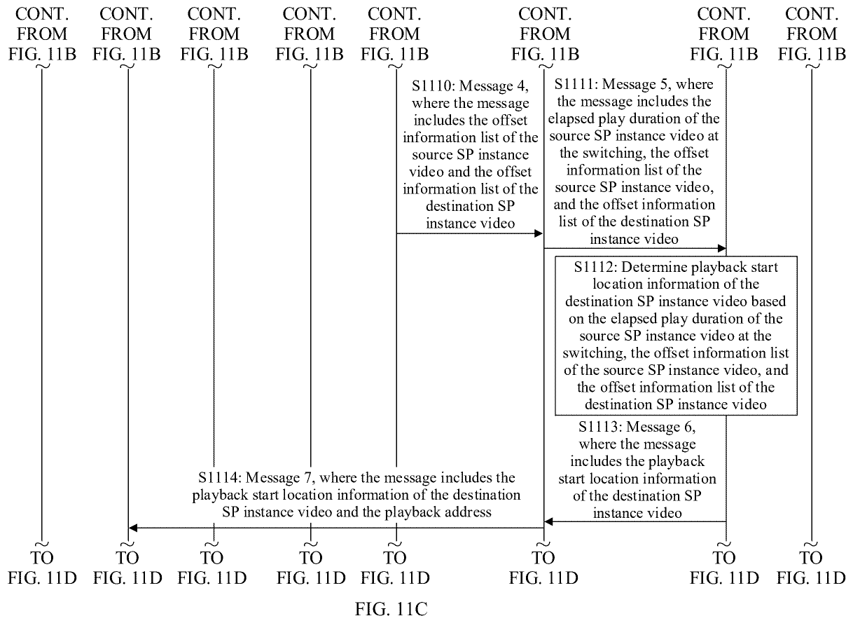

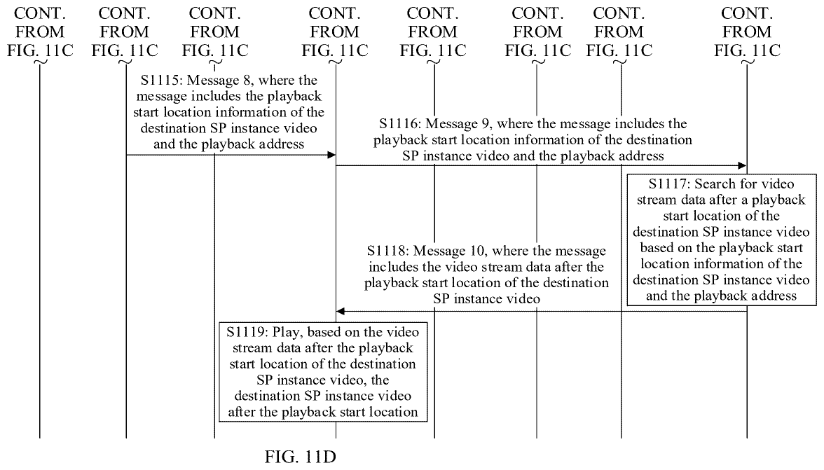

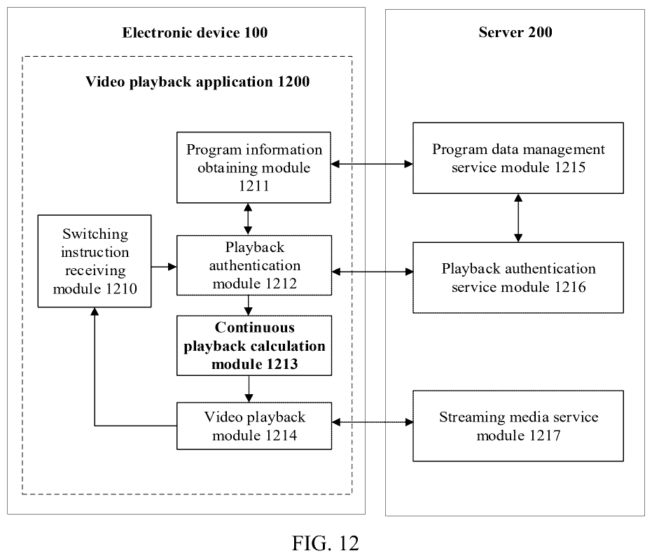

FIG. 12 shows an example of the internal module of the electronic device 100, the internal module of the server 200, and the possible manner of collaboration between the internal modules that are included in the process of performing the video processing method according to this embodiment of this disclosure.

As shown in FIG. 12, the electronic device 100 may include a video playback application 1200. The video playback application 1200 may include a switching instruction receiving module 1210, a program information obtaining module 1211, a playback authentication module 1212, a continuous playback calculation module 1213, a video playback module 1214, and the like. The server 200 may include a program data management service module 1215, a playback authentication service module 1216, a streaming media service module 1217, and the like. The video playback application 1200 may be an application with a video playback capability (for example, Huawei video or Youku video). The server 200 may be a video operation server, for example, a server corresponding to the video playback application 1200.

The switching instruction receiving module 1210 may be configured to receive, after a user performs a switching operation (for example, an operation of switching a clip video to an entire video, or an operation of switching a source SP instance video to a destination SP instance video), a switching instruction sent by the video playback module 1214, exchange data with the playback authentication module 1212, and so on.

The program information obtaining module 1211 may be configured to obtain, from the program data management service module 1215, related information of a to-be-played program, for example, program information of a clip video (for example, an ID of the clip video), program information of an entire video (for example, an ID of the entire video), an association relationship between the clip video and the entire video, an offset information list of each SP instance video associated with the entire video, program information of an aggregated video (for example, an ID of the aggregated video), an offset information list of a source SP instance video, and an offset information list of a destination SP instance video, exchange data with the playback authentication module 1212, and so on.

The playback authentication module 1212 may be configured to exchange data with the switching instruction receiving module 1210, the program information obtaining module 1211, the playback authentication service module 1216, and the continuous playback calculation module 1213, and so on.

The continuous playback calculation module 1213 may be configured to calculate a continuous playback point of a video to which the user needs to switch. For example, in a scenario of switching a clip video to an entire video, a continuous playback point of an SP instance video may be calculated based on elapsed play duration of the clip video at switching, a start location of a segment, and an offset information list of an SP instance video that is associated with the entire video and that can be played by the user. For another example, in a scenario of switching a source SP instance video to a destination SP instance video in an aggregated video, a continuous playback point of the destination SP instance video may be calculated based on elapsed play duration of the source SP instance video at switching, an offset information list of the source SP instance video, and an offset information list of the destination SP instance video. The continuous playback calculation module 1213 may be further configured to exchange data with the playback authentication module 1212 and the video playback module 1214, and so on.

It is easy to understand that this embodiment of this disclosure specifies that the continuous playback calculation module 1213 needs to provide an understanding function and a calculation function of the offset information list.

The video playback module 1214 may be configured to play a video, exchange data with the switching instruction receiving module 1210, the continuous playback calculation module 1213, and the streaming media service module 1217, and so on.

The program data management service module 1215 may be configured to store and manage program information, for example, store program information of a clip video, program information of an entire video, and an association relationship between the clip video and the entire video, exchange data with the program information obtaining module 1211, and so on.

This embodiment of this disclosure specifies that the program data management service module 1215 needs to perform storage and management on the offset information list of the video.

The playback authentication service module 1216 may be configured to, during operation of a program, authenticate, based on operation information of the program (for example, information stored in the program data management service module 1215), information of a video that needs to be played and is reported by the electronic device 100, allocate a playback address of a video stream in the streaming media service module 1217 to the video, send the playback address to the electronic device 100, exchange data with the program data management service module 1215, and so on.

The streaming media service module 1217 may be configured to search for video stream data of a video based on playback start location information and a playback address of the video, send the video stream data of the video to the electronic device 100, and so on.

The foregoing modules may be divided by function. In an actual product, the modules may be different functions executed by a same software module.

For more details about functions of the internal modules of the electronic device 100 and the server 200, refer to related content in the foregoing embodiments. Details are not described herein again.

It may be understood that the structure shown in FIG. 12 does not constitute a specific limitation on the electronic device 100 and the server 200. In some other embodiments of this disclosure, the electronic device 100 and the server 200 may have more or fewer components than those shown in FIG. 12, or a combination of two or more components, or a different component layout. Components shown in the figure may be implemented by hardware including one or more signal processing and/or application-specific integrated circuits, software, or a combination of hardware and software.

The following describes an internal module of an electronic device 100, an internal module of a server 200, and a possible manner of collaboration between internal modules that are included in a process of performing another video processing method according to an embodiment of this disclosure.

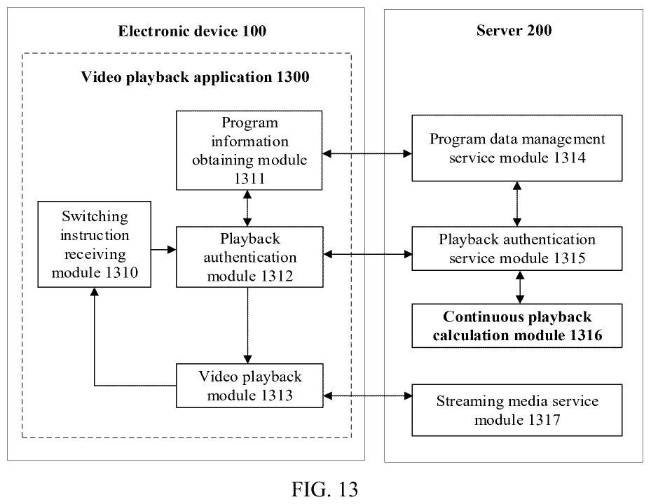

FIG. 13 shows an example of the internal module of the electronic device 100, the internal module of the server 200, and the possible manner of collaboration between the internal modules that are included in the process of performing the other video processing method according to this embodiment of this disclosure.

As shown in FIG. 13, the electronic device 100 may include a video playback application 1300. The video playback application 1300 may include a switching instruction receiving module 1310, a program information obtaining module 1311, a playback authentication module 1312, a video playback module 1313, and the like. The server 200 may include a program data management service module 1314, a playback authentication service module 1315, a continuous playback calculation module 1316, a streaming media service module 1317, and the like. The video playback application 1300 may be an application with a video playback capability (for example, Huawei video or Youku video). The server 200 may be a video operation server, for example, a server corresponding to the video playback application 1300.

For more details about functions of the internal modules of the electronic device 100 and the server 200, refer to related content in the foregoing embodiments. Details are not described herein again.

It may be understood that the structure shown in FIG. 13 does not constitute a specific limitation on the electronic device 100 and the server 200. In some other embodiments of this disclosure, the electronic device 100 and the server 200 may have more or fewer components than those shown in FIG. 13, or a combination of two or more components, or a different component layout. Components shown in the figure may be implemented by hardware including one or more signal processing and/or application-specific integrated circuits, software, or a combination of hardware and software.

The following describes a diagram of a structure of an electronic device 100 according to an embodiment of this disclosure.

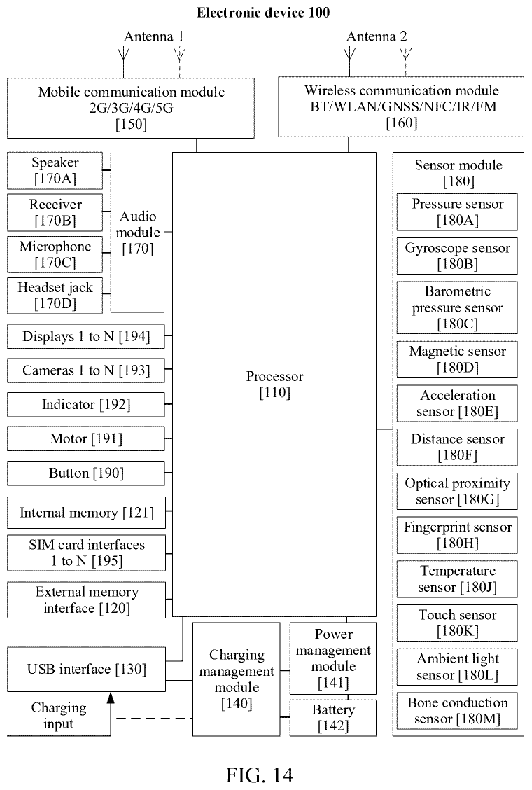

FIG. 14 shows an example of a structure of an electronic device 100 according to an embodiment of this disclosure.

As shown in FIG. 14, the electronic device 100 may include a processor 110, an external memory interface 120, an internal memory 121, a Universal Serial Bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this disclosure does not constitute a specific limitation on the electronic device 100. In some other embodiments of this disclosure, the electronic device 100 may include more or fewer components than those shown in the figure, or a combination of some components, or splits from some components, or a different component layout. The components shown in the figure may be implemented by hardware, software, or a combination thereof.

It should be understood that the electronic device 100 shown in FIG. 14 is merely an example, and the electronic device 100 may have more or fewer components than those shown in FIG. 14, or a combination of two or more components, or a different component layout. Components shown in FIG. 14 may be implemented by hardware including one or more signal processing and/or application-specific integrated circuits, software, or a combination of hardware and software.

The following describes a structure of a server 200 according to an embodiment of this disclosure.

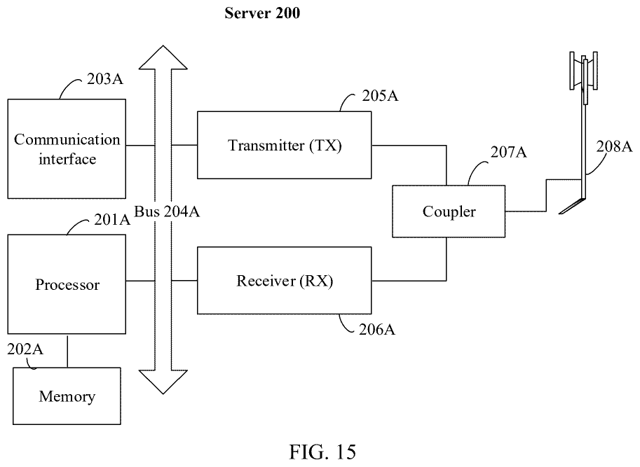

FIG. 15 shows an example of a structure of a server 200 according to an embodiment of this disclosure.

As shown in FIG. 15, the server 200 may include one or more processors 201A, a memory 202A, a communication interface 203A, a transmitter 205A, a receiver 206A, a coupler 207A, and an antenna 208A. These components may be connected through a bus 204A or in another manner. In FIG. 15, an example in which the components are connected through the bus is used.

It should be noted that the server 200 shown in FIG. 15 is merely an implementation in this embodiment of this disclosure. In an actual application, the server 200 may alternatively include more or fewer components. This is not limited herein.

For more details about functions and working principles of the server 200, refer to related content in the foregoing embodiments. Details are not described herein again.

All or some of the foregoing embodiments may be implemented by software, hardware, firmware, or any combination thereof. When software is used to implement the embodiments, all or a part of the embodiments may be implemented in a form of a computer program product. The computer program product includes one or more computer instructions. When the computer program instructions are loaded and executed on a computer, the procedure or functions according to this disclosure are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a DIGITAL VERSATILE DISC (DVD)), a semiconductor medium (for example, a solid-state drive (SSD)), or the like.

A person of ordinary skill in the art may understand that all or some of the procedures of the methods in embodiments may be implemented by a computer program instructing related hardware. The program may be stored in a computer-readable storage medium. When the program runs, the procedures of the methods in embodiments are executed. The foregoing storage medium includes any medium that can store program code, such as a read-only memory (ROM), a random-access memory (RAM), a magnetic disk, or an optical disc.

The foregoing embodiments are merely intended to describe the technical solutions of this disclosure, but are not intended to limit this disclosure. Although this disclosure is described in detail with reference to the foregoing embodiments, a person of ordinary skill in the art should understand that the technical solutions described in the foregoing embodiments may still be modified or some technical features thereof may be equivalently replaced. These modifications or replacements do not enable essence of a corresponding technical solution to depart from the scope of the technical solutions of embodiments of this disclosure.

1. A method comprising:
playing a first video;
displaying a first user interface comprising a first image, wherein the first image is in the first video;
detecting, on the first user interface, a first operation of a user;
playing, in response to the first operation, a second video, wherein the first image is in the second video; and
displaying a second user interface comprising the first image, wherein the first video and the second video are based on a third video, wherein a playback progress corresponding to the first image in the second video is a first time point, and wherein the second video is obtained by inserting one or more first clips into the third video before the first time point or cropping the one or more first clips from the third video before the first time point.

2. The method of claim 1, wherein the first video is in the second video.

3. The method of claim 1, wherein the first video is of a first video source, wherein the second video is of a second video source, wherein a second playback progress corresponding to the first image in the first video is a second time point, and wherein the second time point is different from the first time point.

4. The method of claim 1, wherein before displaying the second user interface, the method further comprises:
sending, to a server, first user information to determine whether the user has a permission to play the second video; and
playing the second video when the user has the permission.

5. The method of claim 2, wherein the first time point is based on the third video, an elapsed play duration of the first video, and an offset information list of the second video, wherein the offset information list comprises offset information of the one or more first clips, and wherein the offset information comprises an offset duration and a location at which the one or more first clips are inserted into the third video or cropped from the third.

6. The method of claim 5, wherein before displaying the second user interface, the method further comprises:
sending to a server, a first message comprising an identifier of the first video, wherein the identifier is for obtaining the offset information list and information about a segmentation point of the third video associated with the first video; and
receiving, from the server, a second message comprising the information about the segmentation point and the offset information list,
wherein the first time point is further based on the information about the segmentation point.

7. The method of claim 5, wherein before displaying the second user interface, the method further comprises:
sending, to a server, a first message comprising the elapsed play duration; and
receiving, from the server, a second message comprising the first time point and a playback address of the second video, wherein the first time point is further based on information about a segmentation point of the third video.

8. The method of claim 1, wherein before displaying the second user interface, the method further comprises:
sending, to a server, a first message comprising the first time point and a playback address of the second video, wherein the playback address is from the server; and
receiving, from the server, video stream data of the second video after the first time point.

9. The method of claim 1, wherein after playing the second video, the method further comprises:
displaying a third user interface comprising a second image, wherein a second playback progress corresponding to the second image in the second video is a second time point, and wherein a first time interval is between the second time point and the first time point; and
obtaining the second video by inserting one or more second clips into the third video or cropping the one or more second clips from the third video at a time period between the second time point and the first time point, wherein a third playback progress corresponding to the second image in the third video is a third time point, wherein a fourth playback progress corresponding to the first image in the third video is a fourth time point, wherein a second time interval is between the third time point and the fourth time point, and wherein the first time interval is different from the second time interval.

10. The method of claim 3, wherein the third video comprises the first image, wherein a third playback progress corresponding to the first image in the third video is a third time point, and wherein the method further comprises:
determining the third time point based on the second time point and a first offset information list of the first video, wherein the first offset information list comprises first offset information of one or more second clips, and wherein the first offset information comprises a first offset duration and a first location at which the one or more second clips are inserted into the third video or cropped from the third video; and
determining the first time point based on the third time point and a second offset information list of the second video, wherein the second offset information list comprises second offset information of the one or more first clips, and wherein the second offset information comprises a second offset duration and a second location at which the one or more first clips are inserted into the third video or cropped from the third video.

11. The method of claim 10, wherein before displaying the second user interface, the method further comprises:
sending, to a server, a first message comprising first identification information of the first video and second identification information of the second video, wherein the first identification information is for obtaining the first offset information list, and wherein the second identification information is for obtaining the second offset information list; and
receiving, from the server, a second message comprising the first offset information list and the second offset information list.

12. The method of claim 1, further comprising obtaining the first time point using a formula, wherein the formula is:
CP′=CP+Σᵢ₌₁ⁿLᵢ,
wherein CP′ is the first playback progress, wherein CP is a second playback progress corresponding to the first image in the third video, wherein n is a total quantity of the one or more first clips, and wherein Lᵢ is an offset duration of an i^{th} first clip in the one or more first clips.

13. An apparatus comprising:
a memory configured to store instructions; and
one or more processors coupled to the memory, wherein the instructions, when executed by the one or more processors, cause the apparatus to:
play a first video, wherein the first video is based on a third video;
display a first user interface comprising a first image, wherein the first image is in the first video;
detect, on the first user interface, a first operation of a user;
play, in response to the first operation, a second video, wherein the first image is further in the second video, wherein the second video is obtained by inserting one or more first clips into the third video before a first time point or cropping the one or more first clips from the third video before the first time point, and wherein a first playback progress corresponding to the first image in the second video is the first time point; and
display a second user interface comprising the first image.

14. The apparatus of claim 13, wherein the first video is in the second video.

15. The apparatus of claim 13, wherein the first video is of a first video source, wherein the second video is of a second video source, wherein a second playback progress corresponding to the first image in the first video is a second time point, and wherein the second time point is different from the first time point.

16. The apparatus of claim 13, wherein before displaying the second user interface, the instructions, when executed by the one or more processors, further cause the apparatus to:
send, to a server, first user information to determine whether the user has a permission to play the second video; and
play the second video when the user has the permission.

17. The apparatus of claim 14, wherein the first time point is based on the third video, an elapsed play duration of the first video, and an offset information list of the second video, wherein the offset information list comprises offset information of the one or more first clips, and wherein the offset information comprises an offset duration and a location at which the one or more first clips are inserted into the third video or cropped from the third video.

18. A computer program product comprising computer-executable instructions that are stored on a non-transitory computer-readable storage medium and that, when executed by one or more processors of an apparatus, cause the apparatus to:
play a first video;
display a first user interface comprising a first image, wherein the first image is in the first video;
detect, on the first user interface, a first operation of a user;
play, in response to the first operation, a second video, wherein the first image is in the second video; and
display a second user interface comprising the first image, wherein the first video and the second video are based on a third video, wherein a playback progress corresponding to the first image in the second video is a first time point, and wherein the second video is obtained by inserting one or more first clips into the third video before the first time point or cropping the one or more first clips from the third video before the first time point.

19. The computer program product of claim 18, wherein the first video is a video clip in the second video.

20. The computer program product of claim 18, wherein the first video is of a first video source, wherein the second video is of a second video source, wherein a second playback progress corresponding to the first image in the first video is a second time point, and wherein the second time point is different from the first time point.
